(19) United States
(12) Patent Application Publication
(10) Pub. No.: US 2011/0226868 A1
(43) Pub. Date: Sep. 22, 2011

(54) Ultrasonic humidifier for repelling insects

(75) Inventors: Kemper O'neal Modlin, Magnolia, TX (US); Leo John Niekerk, Spring, TX (US)

(73) Assignee: Monster Mosquito Systems

(21) Appl. No.: 13/068,807

(22) Filed: May 19, 2011

Related U.S. Application Data
(63) Continuation-in-part of application No. 12/661,358, filed on Mar. 15, 2010.
Application No. 12/661,358 is a continuation-in-part of application No. 11/985,816, filed on Nov. 16, 2007, now Pat. No. 7,712,249.

(51) Int. Cl. A01M 7/00

(52) U.S. Cl. 239/102.1

(57) ABSTRACT

The present invention is directed to an ultrasonic repellent humidifier for dispersing insect repellant into the air as a micro fine repellent vapor. A repellent tank provides rhodinol and cedarwood oil based repellent to a repellent well. An ultrasonic transducer is positioned in the well beneath the level of the repellent. It vibrates, forming a repellant vapor that is drawn into a vapor duct by a forced air system and out of the unit, dispersing the repellent vapor into the surrounding air. The vibrating portion of the ultrasonic transducer that is exposed to the oil-based repellent is a ceramic material that inhibits residue from forming on the transducer that reduces its efficiency. The ceramic material may be formed on the metal case of the transducer or on the piezoelectric oscillation crystal, or it may be a separately replaceable disc.

### CROSS-REFERENCE TO RELATED APPLICATIONS

This application is a continuation in part, related to and claims the benefit of priority to U.S. patent application Ser. No. 12/661,358, filed Mar. 5, 2010, entitled “Ultrasonic Humidifier for Repelling Insects,” which is a continuation-in-part of U.S. patent application Ser. No. 11/985,816 filed Nov. 16, 2007 (now U.S. Pat. No. 7,712,249, entitled “Ultrasonic Humidifier for Repelling Insects,” which is assigned to the assignee of the present invention. The above identified applications are incorporated by reference herein in their entireties.

### BACKGROUND OF THE INVENTION

The present invention relates generally to a device for repelling insects. More particularly, the present invention relates to an ultrasonic humidifier for dispersing insect repellant into the air.

Many types of insects and other nuisance bugs are considered pests, because they transmit diseases, damage structures or destroy agricultural products. Parasitic insects, such as mosquitoes, biting flies (black and greenhead), no-see-ums, lice, chiggers, ticks and bedbugs are notorious for decreasing the enjoyment of the out-of-doors for humans and pets alike. The options for pest control are generally limited to killing/capturing or repelling techniques.

Nuisance pests are typically killed through the application of a pesticide, such as by misting an area (see for example U.S. patent Ser. No. 11/524,073 to Modlin, et al. filed Sep. 20, 2006 and entitled “Automated Pest Misting System with Pump,” assigned to the assignee of the present invention, which is incorporated herein in its entirety), or through the use of bait and trap systems such as fly strips, CO₂/octenol traps or electric bug zappers that attempt to attract pests with scent, heat, chemicals or light, or a combination of the above, and then either trap or kill pests that are lured to the bait. Each of these techniques has the unwanted detriment of killing beneficial insects, such as bees, butterflies, ladybugs and dragonflies, along with the nuisance insects. While there have been some advancements in biocontrol and in luring only nuisance insects to a trap, e.g., luring adult Japanese beetles into traps using beetle pheromones, generally it is difficult to attract unrelated types of nuisance insects to the exclusion of beneficial insects. The term insect will be used hereinafter as synonymous with bugs and/or pests, whether the pests fit the traditional definition of an insect and regardless of whether the pests move around by walking, crawling, hopping, jumping or flying.

To date, one of the most effective method for repelling insects is by applying a coating of insect repellant containing synthesized DEET (n-n-diethylnetatoluamide) over exposed body parts and clothing which mosquitoes might penetrate. Currently DEET is the active ingredient in a wide range of repellants, such as creams, lotions, and aerosols. The disadvantages of using an insect repellant are many. For instance, the oily feel, they cause irritation to eyes, lips and other sensitive areas and can cause a skin reaction with some users, sometimes serious, and DEET is less effective in low concentrations, while higher concentrations may result in an increased risk of reaction. The product will often damage and/or stain certain plastics and fabrics and detractors often complain about the strong ‘chemical’ smell prevalent with DEET usage. Most people avoid using insect repellents around their home unless they intend to be outside for a prolonged period of time. Moreover, insect repellants are inconvenient and bothersome; they detract from the enjoyment with other people, such as on trips to the beach or camping, tailgating or picnicking.

Another, more convenient and environmentally friendly method for controlling nuisance pests in an area, is by application of a repellant throughout a control area. Although electronic repellants exist, such as by generating sound energy electronically at frequencies that repel insects, by far the most effective means is through the application of chemical repellants. Everyone has probably burned citronella to repel mosquitoes or heard of burning citronella in candles or torches or the like. Citronella candles and lamp fuel is relatively inexpensive, nontoxic and fairly easy to use. The active insect repelling ingredient in citronella, PMD (p-menthane 3,8-diol) has been demonstrated to repel mosquitoes, however, the recommended concentration of PMD is approximately ten percent and then citronella usually only repels mosquitoes for ten to twenty minutes. The reason that burning citronella is not always effective is that oftentimes the airborne concentration of PMD is very low, either because of the concentration being burned, or more probably because the dispersion pattern of the citronella fumes is not homogeneous in the control area. Insects do not breathe the way that mammals do and they do not have lungs, but instead they use tracheal respiration to transport air from spiracle openings on the surface of their bodies. Spiracles are located all along the insects' abdomens. It follows that the more effectively a repellent is dispersed in a control area, the more spiracles on an insect's body will receive the repellent. Burning citronella has been reported to form long airborne ‘spider webs’ when burned rather than a homogeneous concentration within the control area. Light breezes that do not affect mosquitoes sometimes move the citronella fumes completely out of the control area. Furthermore, it is difficult to meter the amount of citronella in the air, at best the user lights more or less candles or torches and repositions them in the control area for effectiveness.

Handheld trigger sprayers for broadcasting repellents are well known and widely used, especially around farm animals and in kennels and stables. Certain mosquito repellents are also sprayed from trigger or larger pump sprayers. However, these repellants are generally not meant to remain airborne, but are often applied to ground cover, yards, gardens and campgrounds. Typically, these repellents have an aromatic ingredient, such as concentrated garlic solution, that has some repelling properties, but actually kills most insects that come in contact with it. Automated misting systems, such as those disclosed in the Modlin application identified above, may be altered for dispersing repellents rather than insecticides. It should be mentioned that the Modlin device utilizes misting transducer assembly heads rather than transducer assembly heads. Spraying systems are less effective for repelling flying pests because the particle size ejected from a spray head is relatively large, usually greater than 50 microns, and therefore they do not remain suspended in the air for longer than a very few seconds. A mist has fewer open spaces or gaps between particles than a spray, and is generally less dense and will remain airborne longer than spray particles. Mist infers that the diameter of the suspended liquid is generally between 30 microns and 50 microns.

While misting systems are much more effective for dispensing repellents, the repellent mist will eventually fall out of the air and lose its effectiveness. What is needed is a safe and effective repellant dispersion system for use out-of-doors.

Recently, the inventors of the present invention have disclosed various novel embodiments of ultrasonic humidifiers for vaporizing various compositions of non-toxic pest repellants for repelling pests. These ultrasonic humidifiers, while effective, suffer from shortcomings related to the longevity of the electronics and electrical components used therein. One problem relates to the function of the well level switch used for de-energizing the ultrasonic transducer prior to the repellant level is the repellant well uncovering the ceramic disk over the transducer. Once the fluid over the transducer evaporates, the transducer will rapidly overheat and fail. Another shortcoming, somewhat related to the problem discussed above, is the repellant solution itself.

The presently described ultrasonic humidifiers are designed to accommodate a wide variety of repellant compositions. Some of these compositions have no detrimental affects on the various components of the ultrasonic humidifiers, however, most of these repellant compositions comprise a natural oil base with a surfactant. Thus, if the repellant comes in contact with the electrical components or electronics, an oil film will result that dust, dirt and any contaminates in the air will adhere to (generally, the electronics are cooled using the same air stream that will be used to disperse the repellant evaporate mist). Over a short time, these contaminates and the oil film will cause electrical shorts between individual components and to ground that will cause a failure of the humidifier. Furthermore, some repellant compositions have a low electrical impedance, thereby causing an electrical short circuit between components and ground without the introduction of any airborne contaminates.

### BRIEF SUMMARY OF THE INVENTION

The present invention is directed to an ultrasonic repellent humidifier for dispersing insect repellant into the air as a micro fine repellent vapor. A repellent tank provides rhodinol and cedarwood oil based repellent to a repellent well. An ultrasonic transducer is positioned in the well beneath the level of the repellent. It vibrates, forming a repellant vapor that is drawn into a vapor duct by a forced air system and out of the unit, dispersing the repellent vapor into the surrounding air. The vibrating portion of the ultrasonic transducer that is exposed to the oil-based repellent is a ceramic material that inhibits residue from forming on the transducer that reduces its efficiency. The ceramic material may be formed on the metal case of the transducer or on the piezoelectric oscillation crystal, or it may be a separately replaceable disc.

### BRIEF DESCRIPTION OF THE SEVERAL VIEWS OF THE DRAWINGS

The novel features believed characteristic of the present invention are set forth in the appended claims. The invention itself, however, as well as a preferred mode of use, further objectives and advantages thereof, will be best understood by reference to the following detailed description of an illustrative embodiment when read in conjunction with the accompanying drawings wherein:

FIGS. 1A and 1B show the front and side views of a repellent humidifier for exterior use in accordance with an exemplary embodiment of the present invention;

FIG. 2 is a diagram depicting an exploded cross-sectional view of the sections of a repellent humidifier for exterior use in accordance with an exemplary embodiment of the present invention;

FIGS. 3A, 3B, 3C and 3D are diagrams depicting various views of the nebulizer section of a repellent humidifier for exterior use in accordance with an exemplary embodiment of the present invention;

FIGS. 4A, 4B and 4C are diagrams depicting various views of the repellent tank section of a repellent humidifier for exterior use in accordance with an exemplary embodiment of the present invention;

FIGS. 5A, 5B and 5C are diagrams depicting various views of the base section of a repellent humidifier for exterior use in accordance with an exemplary embodiment of the present invention;

FIGS. 6A and 6B are diagrams depicting cross-sectional views of portions of the tank and nebulizer sections of a repellent humidifier showing the operation of the repellent tank valve in accordance with an exemplary embodiment of the present invention;

FIGS. 7A and 7B are diagrams depicting cross-sectional views of portions of the tank and nebulizer sections of a repellent humidifier showing the operation of the tank level switch in accordance with an exemplary embodiment of the present invention;

FIGS. 8A, 8B and 8B are diagrams depicting cross-sectional views of an ultrasonic transducer installed in a portion of the nebulizer section of a repellent humidifier showing in accordance with various exemplary embodiments of the present invention;

FIG. 9 is a diagram depicting a cross-sectional view of a repellent humidifier showing the air flow and repellent vapor paths in accordance with an exemplary embodiment of the present invention;

FIGS. 10A, 10B, 10C, 10D, 10E, 10F, 10G, 10H and 10I are diagrams of various views of an ultrasonic repellent humidifier in accordance with other exemplary embodiments of the present invention;

FIG. 11A is a cross-sectional view of the transducer assembly and the well level sensor assembly in accordance with one exemplary embodiment of the present invention;

FIG. 11B is a cross-sectional view of the transducer assembly and the fan assembly coupled to the snorkel air vent in accordance with one exemplary embodiment of the present invention;

FIGS. 12A and 12B are cross-sectional views of the tank valve assembly interacting with the well float assembly depicting both the closed valve and the open valve positions in accordance with exemplary embodiments of the present invention;

FIGS. 13A, 13B, 13C, 13D, 13E, 13F, 13G and 13H are diagrams of various views of a portable ultrasonic repellent humidifier in accordance with exemplary embodiments of the present invention;

FIG. 14A is a cross-sectional view of the transducer assembly and the fan assembly coupled to the snorkel air vent of the portable ultrasonic repellent humidifier in accordance with one exemplary embodiment of the present invention;

FIG. 14B is a cross-sectional view of the transducer assembly and the well level sensor assembly of the portable ultrasonic repellent humidifier in accordance with one exemplary embodiment of the present invention;

FIG. 14C is a cross-sectional view of the well level sensor assembly and the tank valve actuating pedestal actuating the tank valve of the portable ultrasonic repellent humidifier in accordance with one exemplary embodiment of the present invention;

FIGS. 15A and 15B are cross-sectional views of the tank valve assembly interacting with the well float assembly depicting both the closed valve and the open valve positions of the portable ultrasonic repellent humidifier in accordance with exemplary embodiments of the present invention;

FIGS. 16A, 16B and 16C are diagrams of a portable ultrasonic repellent humidifier in accordance with exemplary embodiments of the present invention;

FIG. 17 is an exploded diagram of repellent humidifier 200 that further illustrates a highly decomposed view of nebulizer assembly 210 in accordance with another exemplary embodiments of the present invention;

FIGS. 18A and 18B illustrate an ultrasonic transducer having a round vibrating surface, while FIGS. 18C and 18D illustrate another ultrasonic transducer design having a linear-shaped round vibrating surface in accordance with an exemplary embodiment of the present invention;

FIGS. 19A and 19B depict the relationship between base/battery assembly 280, control assembly 250 and tank assembly 240 are graphically represented in accordance with other exemplary embodiments of the present invention;

FIG. 20 depicts a portable patio repellent humidifier 201 in accordance with another exemplary embodiment of the present invention;

FIGS. 21A, 21B and 21C depict remotely positionable transducer assembly that is adaptable to conventional threaded pipe sub 326, such as a hose nibble or the like, in accordance with an exemplary embodiment of the present invention;

FIGS. 22A and 22B disclose the structure and operation of an exemplary embodiment of the present invention for use with remotely positionable transducer assemblies;

FIG. 23A illustrates a suction assembly in accordance with one exemplary embodiment of the present invention;

FIG. 23B illustrates a agitator suction assembly in accordance with one exemplary embodiment of the present invention; and

FIG. 24 is a diagram depicting an automated self-contained reservoir system for automated vaporization of repellant, for efficient control of pests in accordance with an exemplary embodiment of the present invention.

Other features of the present invention will be apparent from the accompanying drawings and from the following detailed description.

### DETAILED DESCRIPTION OF THE INVENTION

Element Reference Number Designations

100: Ultrasonic Humidifier
110: Lid Section
112: Tank Fill Cover
114: Tank Fill Opening
120: Tank Section
121: Repellant
122: Tank Valve
123: Repellant Vapor
124: Tank Float Assembly
125: Tank Float
126: Float Assembly Pedestal
127: Switch Actuating Rod
128: Tank Handle
130: Humidifier Section
131: Nebulizer Volume
132: Repellant Well
133: Sump
134: Ultrasonic Transducer Assembly
135: Ultrasonic Transducer Assembly
136: Well Level Switch
137: Well Level Sensor
138: Tank Level Switch
139: Tank Level Switch Cover
140: Fan
141: Fan Shroud
142: Shroud Louver
143: Fan Motor Support
144: Fan Motor
145: Fan Impeller
146: Optional Battery
147: Optional Battery Charger/Rectifier
148: Optional Low Voltage Input
150: Transformer
151: AC Input
152: GFI Power Switch
163: Well Float Contact
164: Well Float Assembly
165: Well Float
166: Well Assembly Pedestal
170: Control Panel
171: Display
172: Panel Input Buttons/Switches
174: Motion Sensor
175: Transducer Case
176: Transducer Seal
177: Metal Disk
178: Transducer (Piezoelectric Crystal)
179: Ceramic Cover
180: Seal/O-ring
184: Optional Diverter
186: Vapor Duct
188: Vapor Vents/Register
190: Bottom Section
192: Legs
194: Air Vent
196: Fan Shroud
200: Ultrasonic Repellant Humidifier
212: Tank Fill Cover
214: Tank Fill Opening
220: Tank Section
221: Repellant
222: Tank Valve
223: Tank Opening
224: Remote Control (optional)
225: Tank Valve Seal
226: Tank Valve Biasing Spring
227: Tank Valve Shaft
228: Tank Handle
227: Tank Valve Body
229: Tank Valve Body
230: Humidifier/Nebulizer Section
231: Nebulizer Bottom
232: Repellant Well
233: Feet
234: Ultrasonic Transducer Assembly
234A: Ultrasonic Transducer Assembly (Optional)
235: Encapsulated Hollow Pedestal
236: Well Level Switch Assembly
237: Well Level Sensor
238: Well Level Switch Float
239: Magnetic ring
240: Fan Assembly
241: Fan Shroud
244: Fan Motor
245: Fan Impeller
246: Battery (Optional)
248: Tilt Switch (Shut-Off)
251: AC Input Jack (Optional DC)
252: Power Port
262: Transducer Driver Circuit
263: Well Float Contact
264: Well Float Assembly
265: Well Float
266: Well Assembly Pedestal
270: Control Panel
272: Panel Input Buttons/Switches
274: Control Panel Circuit Board
275: Transducer Case
276: Transducer Seal
277: Metal Disk
278: Transducer (Piezoelectric Crystal)
279: Ceramic Cover
280: Transducer Assembly Seal
284: Optional Diverter
286: Vapor Duct
288: Adjustable Vapor Vents/Register
290: Stand Section (optional)
292: Legs
294: Air Vent
295: Vent opening
296: Snorkel Air Vent
297: Vent opening
298: Snorkel Recess
300: Portable Ultrasonic Repellant Humidifier
312: Tank Cover
314: Tank Fill Opening
316: Removable Tank Assembly
318: Tank
319: Tank Valve Air Inlets
320: Tank Section
321: Repellant
322: Tank Valve
323: Tank Opening
324: Tank Handle
325: Tank Valve Seal
326: Tank Valve Biasing Spring
327: Tank Valve Shaft
328: Humidifier Handle
329: Humidifier/Tank Sections Seal
330: Humidifier/Nebulizer Section
331: Nebulizer Bottom
332: Repellant Well
333: Feet
334: Ultrasonic Transducer Assembly
336: Well Level Switch Assembly
337: Well Level Sensor
338: Well Level Switch Float
339: Magnetic ring
340: Fan Assembly
341: Fan Shroud
344: Fan Motor
345: Fan Impeller
346: Battery (Optional)
351: AC Input Jack (Optional DC)
352: Power Port
362: Transducer Driver Circuit
363: Valve Actuator Contact
364: Well Float Assembly
365: Well Float
366: Well Assembly Pedestal
370: Control Panel
372: Panel Input Buttons/Switches
374: Control Panel Circuit Board
375: Transducer Case
376: Transducer Seal
377: Metal Disk
378: Transducer (Piezoelectric Crystal)
379: Ceramic Cover
380: Transducer Assembly Seal
384: Optional Diverter
386: Vapor Duct
387: Splash Hood
388: Vapor Vents/Register
394: Air Vent
395: Vent Opening
396: Snorkel Air Vent
397: Vent opening
398: Snorkel Recess
400: Portable Ultrasonic Humidifier
401: Freestanding Ultrasonic Humidifier
402: Handle
402: Extension
410: Nebulizer Assembly
412A: Concentric Transducer Assembly
413A: Circular Permeable Vibrating Surface Portion
414A: Transducer (Piezoelectric Crystal)
415A: Vibrating Surface
416A: Power Leads
412B: Cantilever Transducer Assembly
413B: Cantilever Permeable Vibrating Surface Portion
414B: Transducer (Piezoelectric Crystal)
415B: Vibrating Surface
416B: Power Leads
417: Transducer Seal (Upper and Lower)
418: Transducer Assembly Retainer
419: Transducer Well/Seat
420: Repellant Well and Wick Assembly
421: Wick
422: Wick Screen/Filter
423: Wick Support Housing
424: Support Housing Lock Ring
425: Wick Support Housing Spring
426: Spring Compression Housing
427: Lock Ring Catch
428: Support Housing Coupler (Male)
430: Transducer Mounting Surface
431: Mounting (LED) Housing
432: Upper Surface (Fan Mounting Surface)
433: Transducer Opening
434: Fan
435: Louvers
436: Fan Inlet
437: Mounting Housing Coupler (Male)
438: LED Bulbs
440: Tank Assembly
441: Outer Housing
442: Repellant Tank
443: Electrical Contacts
444: Conductors
445: Tank Assembly Coupler (Female)
446: Tank Seal
450: Control Assembly
451: Control Switch
452: Power Receptacle
453: Electrical Contacts
454: Conductors
455: Control Assembly Coupler (Male)
456: Power Status Indicator Light
460: Power Controller/Recharger
461: Transducer/Fan/Light Controller
462A: Transducer Driver Circuit
462B: Transducer Driver Circuit
462C: Transducer Driver Circuit
462D: Transducer Driver Circuit
480: Base/Battery Assembly
482: Battery
483: Electrical Contacts
485: Base Assembly Coupler (Female)
490: Power Adapter Assembly
491: Power Jack
492A: USB Power Adapter
492B: 12 VDC Car Power Adapter
492C: 110 VAC Power Adapter
492D: 12 VDC Regulated Solar Panel
500: Automated Ultrasonic Humidifier System
502: Repellant Tank
503: Inlet Tube
504: Suction Tube
506: Filter
520: Dispersing Elements
522: Tubing
523: Transducer Power Conductor
524: Transducer Assembly Head
525: Remotely Positionable Transducer Assembly
526: Threaded Sub
527: Seal
530: Controller Unit
532: Pump Control Switch
534: Low-Pressure Pump
535: Keypad
536: Programmable Controller
537: Display
538: Battery
539: Rotary Switch
540: Battery Charger
541: Charger A/C Port
542: Bus
543: External Connector
544: Reservoir Bus Connector
545: Reservoir Bus
546: Transducer Power Bus
547: External Power Conductor Coupler
550: Controller Unit
551: Mounting Hole
552: Enclosure
553: Mounting Fastener
554: Door
556: Hinges
558: Door Lock
559: Locking Latch
560: Exposed External Control Panel
562: Vapor Button
564: Indicator Lights
565: Auxiliary Coupler
566: OFF Button
572: Solar Recharge Cell
574: Weather Sensor
575: Motion Sensor
576: Optional Vaporization Light
578: Optional Audible Alert
601: Suction Assembly
602: Agitator Suction Assembly
603: Supply Tube
604: Suction Tube
606: Filter
608: Agitator Body
644: Reservoir Bus Connector
645: Reservoir Bus
646: Reservoir Cap
647: Fluid Level Sensor Wire
648: Low Fluid Sensors
649: Reservoir Cap
650: Agitator Motor
651: Empty Sensors
652: Agitator Impeller Shaft
654: Agitator Impeller
656: Agitator Intake Slots
658: Agitator Outlet
700: Automated Misting System
702: Internal Repellant Tank
703: Refill Cap/Tube
704: Suction Tube
706: Pesticide Level
708: Diluted Strata
710: Pressurized Water Source
711: Injector To Pump Tubing
712: Safety Valve
714: Check Valve
734: Pressure Regulator Valve
735: Buttons
736: Programmable Controller
737: Display
738: Battery
740: Battery Charger/Rectifier
741: AC Power Port
742: Injector
750: Controller Unit
752: Cabinet Enclosure
754: Door
756: Drain Valve

Humidifiers are a well known devices for saturating air with water vapor and are of generally two types: evaporative and mechanical. Evaporative humidifiers evaporate water molecules in the air either by raising the temperature of the water (by using a heat coil) or by increasing the surface area of the water and decreasing its surface tension (by using a wick or filter). Vapor type evaporative humidifiers have many disadvantages such as high energy use, residue and scale accumulation and they are often incompatible with ingredients in the water that result from the thermal energy breaking down or altering certain chemical components. Wick-type humidifiers are relatively inefficient in the moderate to high relative humidity range and the wick demands constant cleaning. Mechanical type humidifiers utilize either a spinning impeller or an ultrasonic element to disperse small droplets of water in the air without heating. In the first type, a rotating drum is partially immersed in a water bath and as it spins, it picks up water and flings it at a diffuser, which breaks the water into fine particles that float in the air.

Ultrasonic humidifiers and nebulizers are well known devices for exciting a liquid to such a level that the liquid evaporates without the addition of any thermal energy. Certain medications have a synergistic effect when vaporized, such as vaporizing water with eucalyptus oil for use as a decongestant. One of the selling points of ultrasonic nebulizers is that the vapor they produce has more consistent, uniform and smaller particle size compared to other types of nebulizer technology. Particle size with the impeller type nebulizers can be more varied and larger, simply because of the interaction between the water droplets traveling at different speeds from the drum to the diffuser, whereas ultrasonic vibrations are constant, reliable and steady. It has long been understood that the more uniform, smaller particle sizes makes the medicated mist penetrate more deeply into the lungs. Ultrasonic humidifiers generally operate by imparting mechanical energy to a liquid thereby exciting the liquid molecules without increasing the intrinsic heat of the liquid. Thus, a liquid may be subjected to a rapidly vibrating (or oscillating) component in order to absorb enough mechanical energy to change its physical state through a process known as inertial cavitation. Although the cavitation process appears rather mundane, it is a violent process that sets up mechanical energy fields, such as acoustical, that can damage surrounding mechanisms and is a major source of wear for propellers and impellers. Cavitation occurs at an ultrasonic transducer which vibrates rapidly, first oscillating in the negative direction which creates an ultra-low pressure void in the water adjacent to the transducer that pulls in water vapor and then in the positive direction that forces the water vapors into bubbles and away from the transducer; the result is often referred to as ‘pulverized water.’ This vibrating energy also has a detrimental effect of breaking down certain unstable components into potentially harmful subspecies and ions which may damage certain components of the device, in much the same manner as heating the liquid might. Therefore, humidifiers are not suitable for vaporizing every type of liquid. Furthermore, the entire device is subjected to emersion in the vaporized liquid, so every part of the device is exposed to potentially detrimental effects of the vaporized liquid compounds. Consequently, humidification and nebulizing devices are typically employed in highly structured environments and under supervised conditions.

Ultrasonic type humidifiers are well known in the prior art as exemplified by U.S. Pat. Nos. 4,752,422, 4,752,423 and 4,921,639, which are incorporated herein by reference in their entireties. These describe, generally, a unit with a water well in which a high frequency ultrasonic transducer is immersed. The transducer typically comprises a piezoelectric crystal which vibrates rapidly, producing a fine water vapor which is dispersed into the atmosphere by an air current from a blower fan.

Mechanical humidifiers do not selectively atomize only water but they disperse water and whatever contaminants are contained in the water at approximately proportional concentrations. Therefore, mechanical humidifiers will disperse repellants effectively without some of the disadvantages associated with heating the liquid repellent. However, because ultrasonic humidifiers do not thermally vaporize only the water molecules, or disinfect it, they also disperse any suspended material in the water to the air such as microorganisms and minerals.

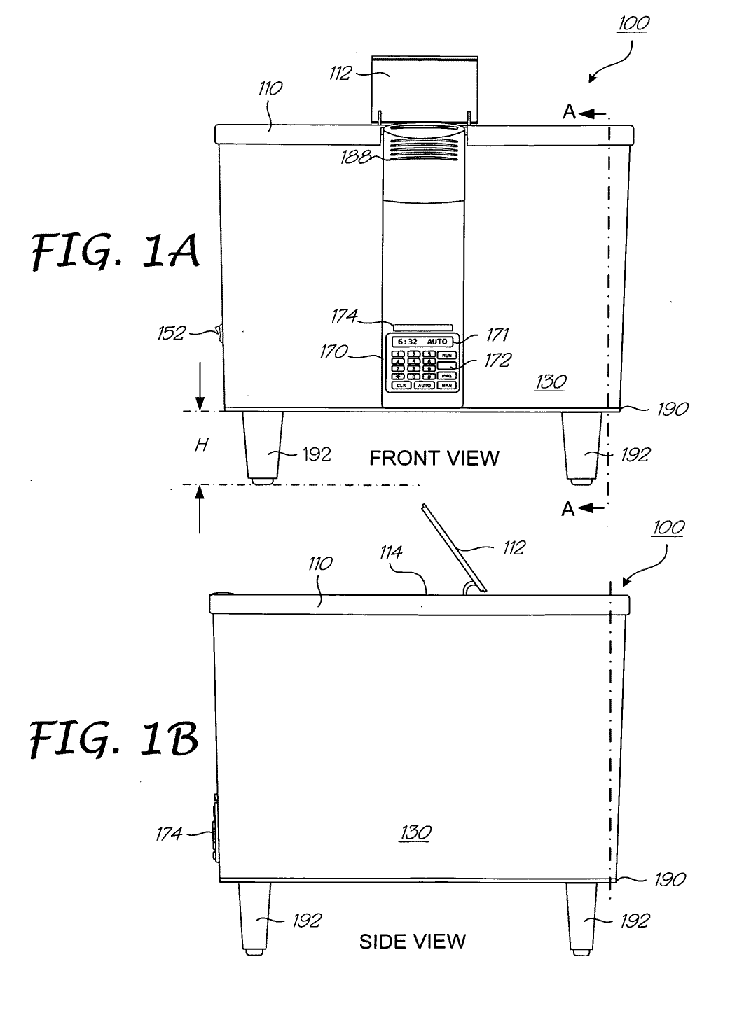

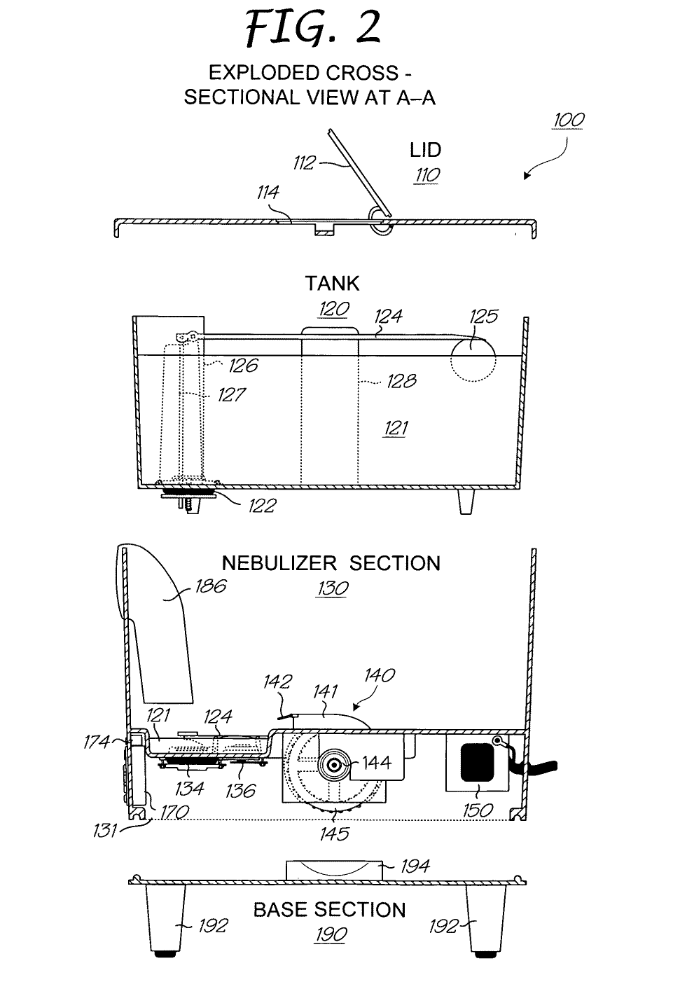

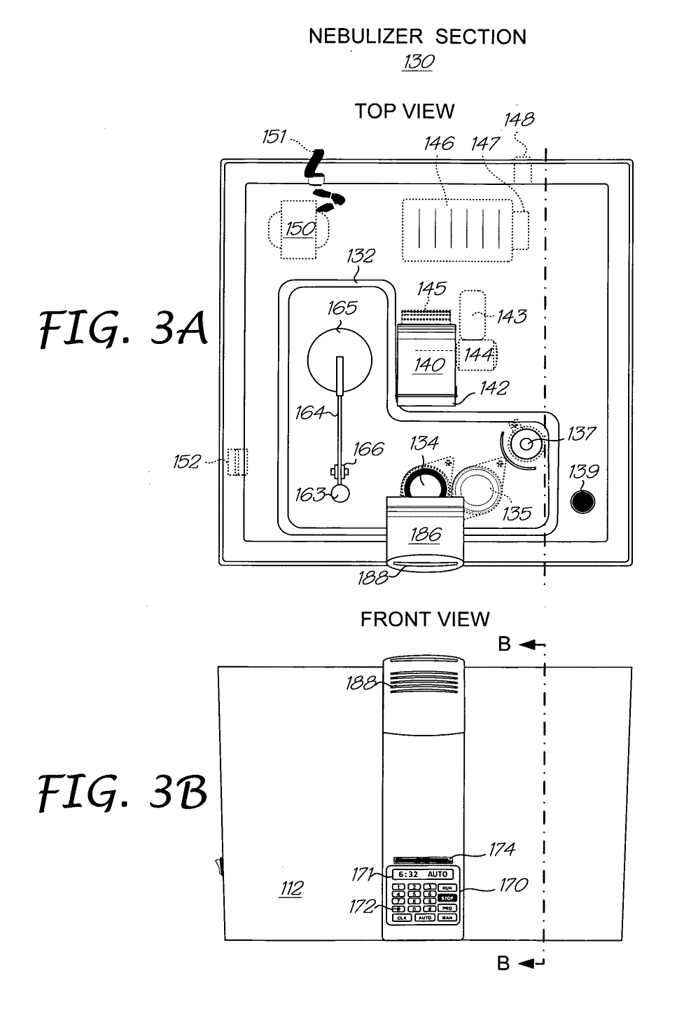

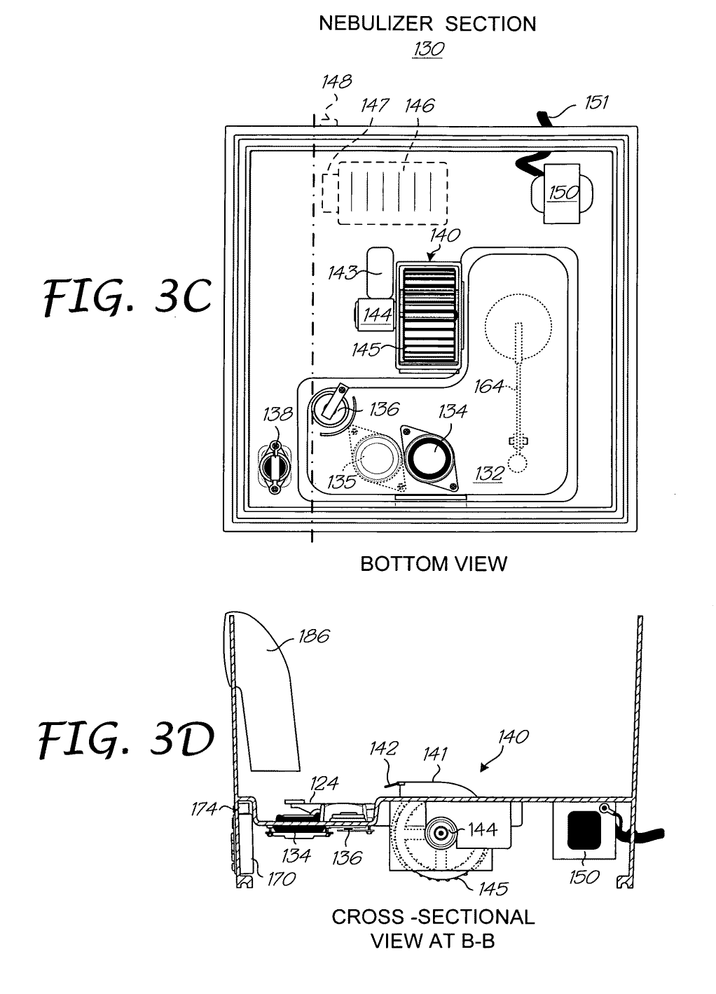

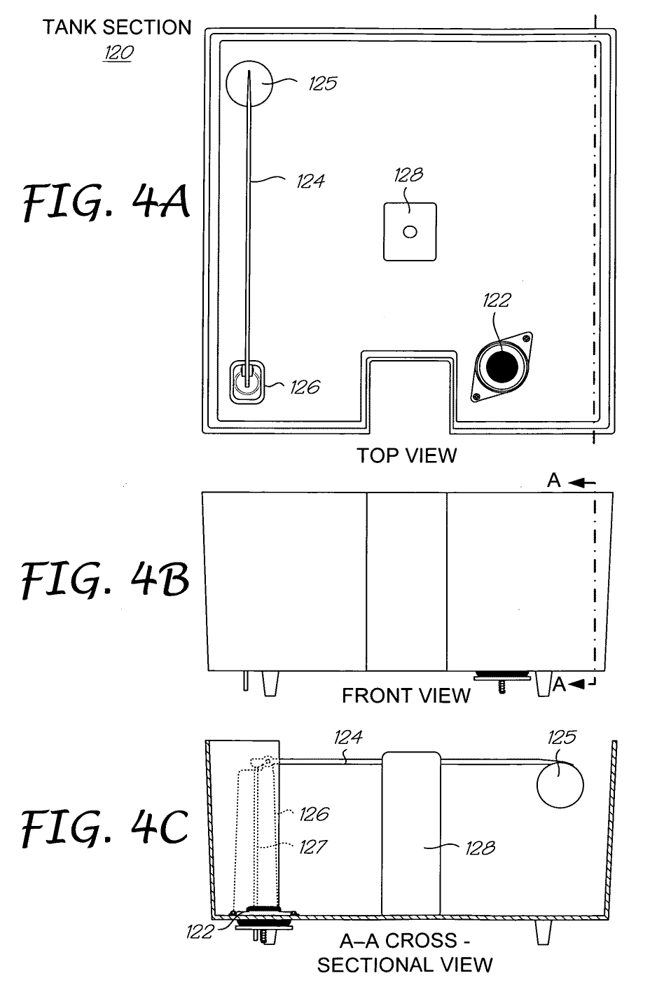

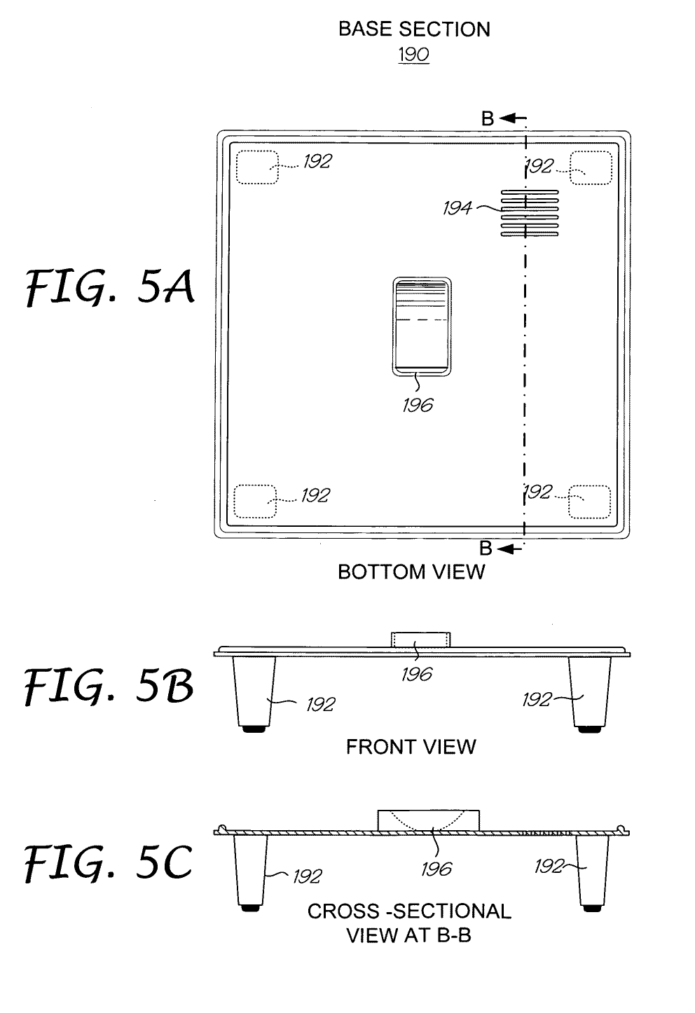

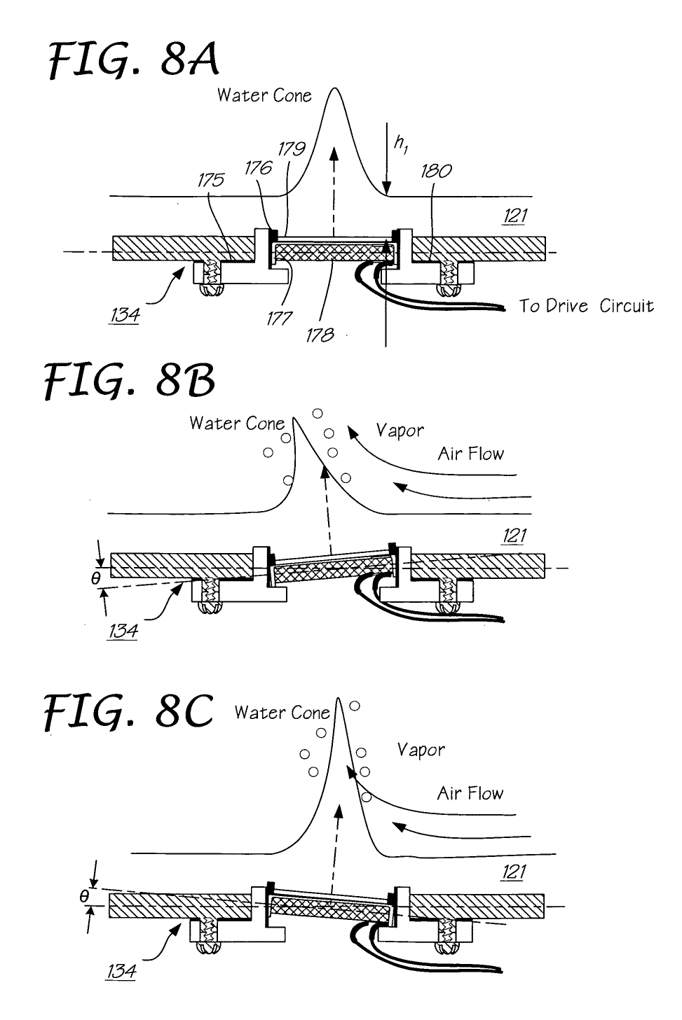

The present invention relates to an ultrasonic humidifier suitable for dispersing repellents for repelling nuisance insects in an exterior environment. FIG. 1 through FIG. 5 are diagrams of the different views of an ultrasonic repellent humidifier in accordance with exemplary embodiments of the present invention. FIGS. 1A and 1B show the front and side views of the external features of repellent humidifier 100. As will be discussed below, repellent humidifier 100 generally comprises four discrete sections: lid section 110; tank section 120 shown in FIG. 4; nebulizer section 130 shown in FIG. 3; and bottom section 190 shown in FIG. 5 (see also the exploded cross-sectional views shown in FIG. 2). Repellent humidifier 100 is an automated repellent dispersing system for exterior usage that is relatively maintenance free. It disperses cool vaporized repellent in the air having particle sizes between 0.03 microns and 15.0 microns depending on the surface tension and viscosity of the repellent and the operating frequency of the ultrasonic transducer. The transducer, which will be discussed in greater detail below with regard to FIG. 8, will operate at the resonance frequency of the piezoelectric crystal it is made from, but optimally will operate between 1600 kHz to 1750 kHz, which may be excited by a drive current oscillating at approximating the resonance frequency of the piezoelectric crystal. In operation, repellent humidifier 100 is intended for exterior use only, therefore all of the components should be sealed and water tight to avoid humidity related failures and should meet Underwriters Laboratories Inc. certification requirements.

Turning to FIGS. 1A and 1B, repellent humidifier 100 has control panel 170 with buttons/switches 172 for programming its operation and display 171 for monitoring inputs and operating parameters. Buttons/switches 172 of control panel 170 is depicted in the exemplary embodiments as being attached to repellent humidifier 100, but in accordance with other embodiments buttons/switches 172 may be an detachable handheld remote for programming control panel 170. For simplicity, all of the processing, memory, control, timing and safety components for repellent humidifier 100 are represented by control panel 170. Optionally, repellent humidifier 100 may have motion sensor 174 for sensing local motion and initiating an automated run sequence for dispensing repellent at vents 188 (depicted in the exemplary embodiment as being a single stationary vent but may be louvered and/or adjustable for dispersing the repellent in a particular direction and/or multiple vents for dispersing mist simultaneously in multiple directions). Tank fill cover 112 is provided in lid 110 that exposes fill opening 114 for replenishing the volume of tank 120 with repellent 121. Tank fill cover 112 is provided with a water resistant sealing gasket for forming a water tight bond with lid 110 and around fill opening 114. As the unit is designed for exterior usage, it will be exposed to direct and indirect ultraviolet (UV) rays from the sun, so the outer shell material must resist ultraviolet light or have a UV protective coating added. Furthermore, repellent 121 may also be sensitive to ultraviolet light, so the entire structure of the unit should be opaque to block harmful UV rays from reaching repellent 121. The inner compartments, tank section 120 should be constructed from chemical resistant material, such as polyethylene, in order to resist damage from repellents. It should be mentioned that although the exemplary embodiment discussed here shows tank 120 above well 132, thereby using a gravity feed for replenishing well 132 with repellant, other configurations are possible without departing from the scope and spirit of the present invention, for instance with the repellant well positioned above the repellant tank, wherein the repellant is moved from the tank to well mechanically using a pump, absorbent wick or dipper (not shown with the exception of the absorbent wick). The use of a mechanical repellant transfer system is particularly advantageous for moving repellant long distances between the tank and well, thus enabling transducers to be position remotely from the repellant tank, thereby allowing for a greater area of repellant protection.

One exemplary repellent for use in repellent humidifier 100 is a composition of geraniol (sometimes referred to as rhodinol which is derived from the Geranium plant but also may occur naturally in lemon, citronella and other essential oils), cedarwood oil and a surfactant (approximate concentrations geraniol 4%, cedarwood Oil 1%, surfactant, such as sodium lauryl sulfate 0.75% with inert ingredients of xanthan gum, citric acid and water in the remaining 94.25%). The insect repelling properties of geranium plants have been long understood and Geraniol, an ingredient extracted from geranium oil, provides a natural, safe and extremely effective insect repellent. Geraniol has been tested by the University of Florida, and has been proven in various laboratory and field tests to be the best available flying insect repellent available, even better than DEET. Geraniol is a natural, pesticide-free product, which requires no EPA registration. Cedarwood oil, which has been touted as being an effective treatment for many hair and skin disorders, congestion and coughs, also has proven repellent properties. In addition, it lends a light musky wood scent to the fragrance of the Geraniol. Because both geraniol and cedarwood oil are lighter than water, a surfactant must be used as a wetting agent that lowers the surface tension of the two oils with the water, allowing for easier mixing and lowering of the interfacial tension between the oils and water. Other natural repellents that may be substituted or used in addition to those above and are listed as inert ingredients eligible for FIFRA 25(b) pesticide products, as well as section 4A ingredients by the EPA are citronella oil (Cymbopogon Winterianus), lemongrass oil (Cymbopogon Citratus), rosemary oil (Rosemarinus Officinalis), Wintergreen oil (Gaultheria Procumbens), thyme oil (Thymus Vulgaris), cedarwood oil alcohols, cedarwood oil terpenes and sodium lauryl sulfate. Directly below is a partial list of EPA 25(b) exempt active ingredients that have been shown or suspected to possess repellant properties.

TABLE I
EPA list of 25(b) exempt active ingredients

Castor oil (U.S.P. or equivalent)*
Cedar oil
Cinnamon and cinnamon oil*
Citric acid*
Citronella and Citronella oil
Cloves and clove oil*
Corn gluten meal*
Corn oil*
Cottonseed oil*
Dried Blood
Eugenol
Garlic and garlic oil*
Geraniol*
Geranium oil
Lauryl sulfate
Lemongrass oil
Linseed oil
Malic acid
Mint and mint oil
Peppermint and peppermint oil*
2-Phenethyl propionate (2-
phenylethyl propionate)
Potassium sorbate
Putrescent whole egg solids
Rosemary and rosemary oil*
Sesame (includes ground
sesame plant) and sesame oil*
Sodium chloride (common salt)*
Sodium lauryl sulfate
Soybean oil
Thyme and thyme oil*
White pepper
Zinc metal strips (consisting
solely of zinc metal and impurities)

In accordance with various exemplary embodiments of the present invention, the active ingredient percentages may be adjusted depending on the application and usage requirements. For instance, a typical concentration of active ingredient may range from 0.2% for ready-to-use humidifier applications to 3.0% for ready-to-use spray applications. Furthermore, a particular repellant or repellant composition might be available in ready-to-use concentrations for both type of application or alternatively might be available in a concentrate form of 8.0% to be diluted to 0.2% or 3.0% by the operator depending on the application it will be used.

TABLE II

| | Concentration by Active Ingredient | | |
|---|---|---|---|
| | Ready-to-Use | | |
| Ingredient | (Hudmifier) | Direct Spray | Concentrate |
| Cedar Oil (aka | 0.6% | — | 2.0% |
| Cedarwood Oil) | | | |
| Cinnamon Oil | 0.5% | — | — |
| Citronella | — | 4.0% | — |
| Clove Oil | 1% | — | — |
| Geraniol | 0.2% | 3.0% | 8.0% |
| Lemongrass Oil | 0.5% | — | — |
| Lemon Eucalyptus | — | 30.0% | — |
| Peppermint Oil | 0.04%-1.0% | — | 2.0% |
| Rosemary Oil | 0.19%-2.0% | — | 10.0% |
| Sodium Lauryl | 0.04% | — | 1.5% |
| Sulfate* | | | |
| Thyme Oil | 0.04%-1.0% | — | 2.0% |

*Sodium lauryl sulfate may be combined with most oil-based repellants as a surfactant agent

In addition to humidifier and direct spray applications, the above-mentioned repellants and repellant compositions are complete safe for topical applications directly on the skin, unless the user is allergic or hypo allergic to similar substances. Therefore, although vapor dispersion by the presently described ultrasonic repellent humidifier is the most efficient use of the repellant product, there repellant may also be dispersed into the air or as a topical treatment using a trigger pump sprayer or the like. Additionally, the aforementioned repellants may also be applied topically by as a lotion from pre-moistened personal towellets (wipes) or by manually saturating an absorbent fabric with repellant. It should be motioned that while many of these repellants and repellant compositions are effective against pests, they are not always tolerated when dispersed in a humidifier in a vapor from. For example, eucalyptus and lemon-eucalyptus compositions are extremely effective repellants and absolutely safe. However, the odor of eucalyptus is not particularly pleasing to humans and other scents, such as citronella have been preferred, especially for social gatherings.

One disadvantage of using an oil based repellent is that it tends to reduce the effective life expectancy of the ultrasonic transducer and other electrical components. The repellent oil readily adheres to metal surfaces. As the repellent is atomized, a residue of oil and oil byproducts is left on the vibrating part of the transducer (the diaphragm). This coating immediately reduces the efficiency of the energy transfer between the transducer and liquid and left untreated, it thermally isolates the transducer from the liquid, thereby accelerating thermal failure. Another problem is that the humidifier components that come in contact with the repellent vapor will eventually exhibit a thin oil film. While this film is easily cleaned from the exterior, its conductive properties will shorten the life expectancy of high voltage and electronic components it contacts.

In accordance with one exemplary embodiment of the present invention, repellent humidifier 100 comprises nebulizer volume 131 which contains all of the electrical components, has forced ventilation for air cooling, but is isolated from the repellent vapor generated in nebulizer section 130; see nebulizer section 230 of FIG. 3. Nebulizer volume 131 is defined by the horizontal portion and lower sides of nebulizer section 130 and base section 190. As depicted in FIGS. 2 and 3A through 3D, contained within nebulizer volume 131 is transformer 150 that receives AC power from three-pronged external power cord 151 coupled through GFI power switch 152. Control panel 170 that receives power from transformer 150 and both ultrasonic transducer assembly 134 and blower assembly 140 receive controlled power and/or drive currents from control panel 170. Although the present repellent humidifier 100 is depicted as a stationary device that receives power from a household AC power supply, the device consumes relatively little electricity and can, therefore, be powered by optional battery 146 that is recharged via optional battery charger/rectifier 147, or instead receive power directly from a 12 VDC source through optional low voltage input 148. Thus, repellent humidifier 100 may be operated from a car battery for trips to the beach or camping, tailgating or picnicking.

Blower assembly 140 is depicted as comprising motor 144, mechanically coupled to squirrel cage fan 145 and which is enclosed on the lateral and top sides by fan shroud 141. Fan shroud 141 has an air intake inlet (not shown) in a center portion of shroud 141 proximate to the axle of motor 144 and an exhaust outlet above the horizontal portion of nebulizer section 130 (the lowermost portion of the fan shroud is affixed to base section 190, shown in FIGS. 5A through 5C as lower fan shroud 196). That exhaust opening is movably covered by shroud louver 142 when blower assembly 140 is idle, thereby isolating nebulizer volume 131 from any vaporized repellent that may be present in the nebulizer section 130 and protecting the electrical components located therein. Blower assembly 140 is depicted as a squirrel cage fan but may be any type fan system.

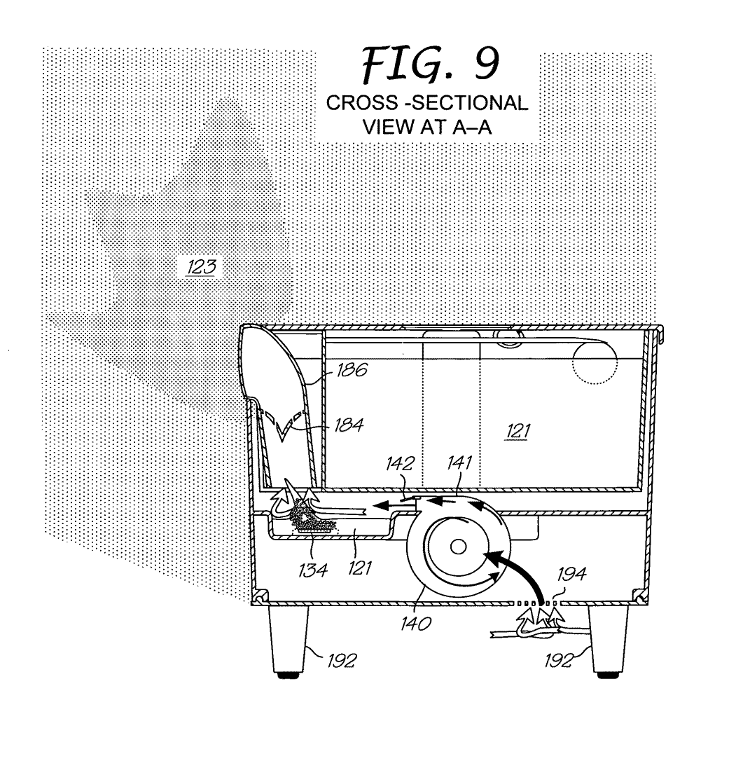

Briefly turning to FIG. 9, air from blower 140 is directed toward the surface of repellant 121 in well 132 proximate to the vibrating surface of ultrasonic transducer 134. As repellent is vaporized, it is forced out of well 132 and into the stream of air from shroud 141. Directing the air stream toward the vibrating surface of ultrasonic transducer 134 keeps the upper level of repellent in well 132 agitated, thereby lessening instances of oil and other contaminants adhering to the vibrating surface of the transducer. The repellent vapor mixes with the moving air and is swept upward into vapor duct 186 and egresses repellent humidifier 100 at vapor vents/register 188. While vents 188 are depicted in the figures as stationary openings from a single vapor duct 186, vents 188 may instead be comprised of louvers and/or repositionable register vents for altering the direction and dispersing pattern of the repellent and/or as a plurality of openings from a single vapor duct or multiple vapor ducts.

The present invention is intended to disperse a micro fine vapor of repellent particles into a control area. However, directing the air stream toward the surface of the repellent sometimes causes larger droplets of repellent to enter vapor duct 186 with the repellent vapor. This condition is more prevalent at higher air velocities and with the use of high energy transducers that tend to form tall water cones over the vibrating disc (see FIG. 8A). Repellent adhering to the sides of vapor duct 186 may be also swept out of the humidifier as large droplets of repellent. Any type of dispersal pattern other than a micro fine vapor of repellent particles is an inefficient use of the repellent. Slotted inverted cone-shape diverter 184 may be installed in the throat of vapor duct 186 as shown in FIG. 9. Slots in inverted cone-shape diverter 184 provide high speed paths for channeling micro particles of repellent that are away from the sidewalls and away from the center of the duct. The obstructions along the circumference and center of inverted cone-shape diverter 184 collect larger and slower droplets and provide a path of relatively calm air for the larger droplets to return to well 132 either along the sidewalls of duct 186 or at the center of the cone.

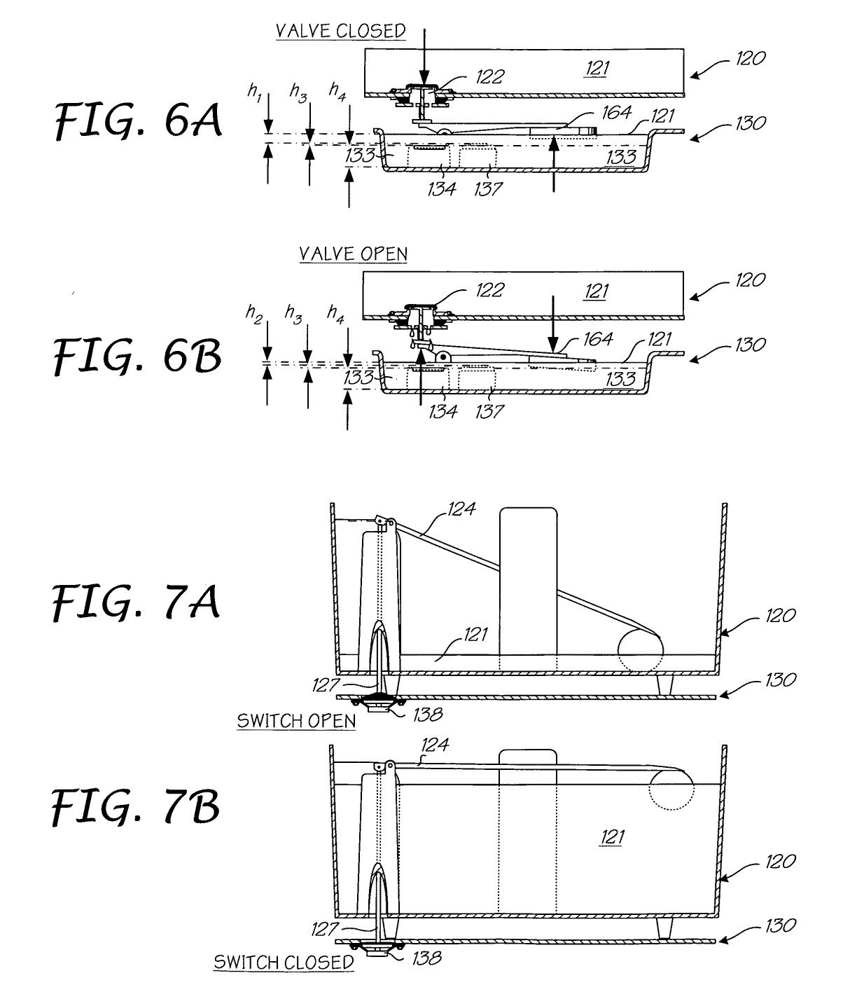

During operation, repellent 121 resides in repellent well 132, completely covering the vibrating portion of ultrasonic transducer assembly 134 and well level sensor 137 (which is electrically coupled to switch 136). At least a portion of well float 165 of float assembly 164 is also immersed in repellent 121 of well 132. Well float 165 tracks the level of the repellent 121; as the repellent is vaporized from well 132, the fluid level drops causing well float contact 163 to engage and actuate tank valve 122 (see FIGS. 5A and 5B). Once actuated, tank valve 122 releases repellent from tank section 120, thereby replenishing repellent 121 in well 132 to a predetermined level (see FIGS. 7A and 7B). Optimally, the level of repellent 121 in well 132 is approximately 1.0 in. to 1.75 in. above the vibrating surface of transducer assembly 134, depicted as distance h₁ in FIGS. 6 A and 6B.

Those of ordinary skill in the art will readily understand that the present embodiment is exemplary in nature designed for ease in understanding the present invention and than many of the components may be substituted with equivalent components or eliminated altogether. For instance, the mechanical level indicators (tank float assembly 124 and well float assembly 164) described herein may be substituted with electronic fluid level measurement devices. However, one advantage of using a mechanical device for maintaining the repellent level in well 132 is that the well will be filled regardless of whether or not repellent humidifier 100 is connected to an electrical power source. Anytime the repellent evaporates, an oil residue is left on the surfaces. Thus, if repellent 121 evaporates from well 132, a film residue will be left on the upper surface of the transducer, which may lower its efficiency, or worse, lower its operational life.

The repellent level in well 132 should remain at least 0.25 in. to 0.5 in. above the vibrating surface of transducer assembly 134, depicted as distance h₂ in FIGS. 6A and 6B. Therefore, well float assembly 164 should actuate tank valve 122 where h₂>0.25 in., preferably 1.0 in.>h₂>0.5 in. The heat generated by transducer assembly 134 during operation is dissipated by repellent 121 in well 132. If the surface of transducer assembly 134 is uncovered, the transducer will fail in short order. As a safety precaution, well level sensor 137 is positioned approximately 0.125 in. to 0.25 in. above the surface of transducer assembly 134, depicted as distance h₃ in FIGS. 6A and 6B. When well level sensor 137 senses well 132 is running dry and the vibrating surface of transducer 134 is in jeopardy of becoming uncovered, i.e., h₃≈0.125 in., well level sensor 137 will actuate well level switch 136, which in turn signals control panel 170 to deactivate the ultrasonic transducer. In order to prevent repellent humidifier 100 from cycling on and off, control panel 170 may delay any action until it receives a constant signal from well level switch 136 for five or ten seconds, thereby ensuring that well 132 is running dry and not receiving a false report from well level sensor 137 from being temporarily uncovered by a combination of a low repellent level and turbulence in the repellent from the air flow. Once the signal has been accepted, control panel 170 will then immediately turn off the ultrasonic transducer and flash a low fluid warning across display 171. Control panel 170 may also immediately turn off the blower assembly, or in accordance with another exemplary embodiment of the present invention, control panel 170 may instead delay disengaging blower 140 for a few seconds. By allowing the blower to continue running for a few seconds after the ultrasonic transducer is switched off, any repellent vapor still inside repellent humidifier 100 is exhausted to the atmosphere before it can settle down into nebulizer volume 131 and contaminate the electrical components there within. Control panel 170 may run blower 140 for a few seconds following any run cycle to vent repellent vapor from repellent humidifier 100.

Also located within nebulizer volume 131 is tank level switch 138 which is a second safety switch for alerting the user that the repellent tank is in need of refilling, thereby avoiding an unnecessary interruption in dispensing repellent. The low level alert may be any or all of an indicator light, audible alarm and text or error message displayed on display 171. Tank level switch 138 is a spring loaded, normally open switch that protrudes through the horizontal surface of nebulizer section 130 at tank level switch cover 139. Tank switch level cover 139 seals nebulizer volume 131 but does not impede the movement of the switch. Turning to FIGS. 4A, 4B, 4C, 7A and 7B notice that tank float assembly 124 is hingedly attached to float assembly pedestal 126 above the highest level for repellent 121 within tank section 120. Switch actuating rod 127 extends from tank float assembly 124, through the interior of float assembly pedestal 126 and engages tank level switch 138 through tank level switch cover 139. As the level of repellent 121 in tank section 120 recedes, ball 125 tracks the fluid level causing switch actuating rod 127 to move up. At some point, switch actuating rod 127 displaces tank level switch 138 enough to activate the switch and signal the user that the repellent should be replenished.

Tuning again to FIGS. 5A through 5C, base section 190 of repellent humidifier 100 is shown in accordance with an exemplary embodiment of the present invention. Base section 190 seals the lowermost portion of nebulizer volume 131 and should form an air and water-tight seal. When in place, lower fan shroud 196 cooperates with fan shroud 141 of nebulizer section 130 completely enclosing fan impeller 145 except for the intake opening (not shown). Blower assembly 140 draws fresh air from the exterior of repellent humidifier 100 through air vent 194 and into nebulizer volume 131. The fresh air circulates around the electrical components prior to being captured by fan 145 and forces through shroud 141, past open louver 142 and into nebulizer section 130. Because repellent humidifier 100 draws air from beneath base section 190, legs 192 should provide clearance of approximately 2.0 in. In accordance with other embodiments, air vent 194 may be located on a sidewall of nebulizer section 130, below its horizontal surface.

In the exemplary configuration using a single ultrasonic transducer, repellent humidifier 100 will continuously repel insects from a 1,000 sq. ft. control area for thirty hours while consuming approximately two gallons of repellent. Control panel 170 includes a programmable menu for scheduling repellent treatment at a predetermined time, such as in the morning and evening hours of weekends when people are about and insects are most active. Control panel 170 also incorporates a programmable countdown time for activating the device for a preset time period. Then, a user merely activates button 172 labeled AUTO, and repellent humidifier 100 disperses repellent for the preset time period. One method of extending the repellent is by dispersing it in short cycles for a preset time period, rather than in a continuous dispersion, for instance alternating cycles of ten minutes ON and five minutes OFF, or cycles of five minutes ON and ten minutes OFF. Alternatively, a manual override RUN button may also be included for running the unit longer than the preset time period. Humidifiers designed for internal use will often have a moisture sensitive rheostat for deactivating the run cycle at a predetermined relative humidity, and thus not inducing too much moisture into the air. Because repellent humidifier 100 is designed for outdoor use, sensing the surrounding relative humidity may be of little importance since the outdoor relative humidity would probably override the dispersing time period causing the device to shut off too early, especially in humid climates. Furthermore, because the present invention disperses micro fine particles of repellent, only a small amount of repellent is necessary for controlling nuisance insects, and the moisture content of the ambient air (the relative humidity) may not be affected. Instead, repellent humidifier 100 may include an optional motion detector 174 for sensing movement and dispersing repellent in conjunction with movement. This feature is even more important for use in areas that need insect control when humans are not present to activate the device. These are places where parasitic insects may be attracted for nonhuman hosts, and may transmit Lyme disease, heart worms, viral encephalitis, Eastern and Western equine encephalitis, West Nile virus and the like to their nonhuman hosts. Included in these places are aviaries, barns, kennels, stables and dairies.

As depicted in the figures of the exemplary embodiments, tank section 120 will accommodate one and a half to four gallons of repellent, but in accordance with other exemplary embodiments of the present invention the tank may hold ten or more gallons of repellent. Repellent humidifier 100 is depicted as having only a single ultrasonic transducer 134. The exposed portion of the vibrating surface should be approximately 2.0 in. in diameter to vaporize enough repellent to efficiently repel insects from a 1,000 sq. ft. control area. In accordance with other exemplary embodiments depicted in FIGS. 3A and 3C, the repellent humidifier may be configured with multiple ultrasonic transducers, either to increase its capacity or longevity. There, exemplary ultrasonic transducer 134 is depicted as being supplemented with a second transducer, exemplary ultrasonic transducer 135, but others may also be included. In accordance with one exemplary embodiment, the multiple ultrasonic transducers may be activated simultaneously in order to increase the capacity of the unit for control areas greater than 1,000 sq. ft. Alternatively, the multiple ultrasonic transducers may be activated alternatively in order to extend that time between transducer services. The present configuration of repellent humidifier 100 may be further optimized by using a dual speed blower for more rapidly dispersing repellent at start up. After a predetermined time has elapsed, the blower reverts to its normal and slower run speed.

Turning now to FIGS. 8A, 8B and 8C, the construction and operation of an ultrasonic transducer is shown in accordance with exemplary embodiments of the present invention. As mentioned elsewhere above, ultrasonic transducers for vaporizing water abound and are extremely well known. However, those designs are intended for interior usage and for vaporizing water having a purity consistent with drinking or pool water. Using such humidifier designs out-of-doors for oily repellents will result in failure from a variety of factors. All else being equal, the purity of the air ingested by the present repellent humidifier also presents a serious challenge as outdoor air contains large concentrations of dust, pollen, spores, mold and bacteria not usually present indoors. These contaminants present two separate problems: hygiene and maintenance. One solution to molds and bacteria is to deposit aqueous silver ions to well 132, such as by using the Ionic Silver Stick water purification technology (Ionic Silver Stick is registered by and available from Plaston AG of Switzerland). These silver ion cartridges last approximately one year and then must be replaced. Additionally, the interior surfaces of the humidifier may be coated or impregnated with an antimicrobial substance such as Microban (Microban is registered to and available from Microban International Ltd. of New York, N.Y.).

Even though these solutions will suppress the growth of harmful bacteria, mold and some viruses, they do little to stem the inordinate amount of contaminants ingested into the unit from the air stream. Obviously, filtering air at air vent 194 will reduce the amount of contaminants entering the system, but a filter adds an additional maintenance item for the user. As a practical matter, the vast majority of contaminates will travel straight through the device, and while they will have an effect on particle size, they will not reduce the effectiveness of the particle size to any measurable amount. Some particles will, however, be captured by liquid repellent 121 in well 132. Those contaminants are first addressed by the design of well 132. A reservoir well in a typical humidifier is usually an inch deep or less. The vibrating surface of the ultrasonic transducer is positioned near the bottom of the well (with the exception of perhaps the fluid level indicator, the transducer is near the deepest portion of the reservoir). Any contaminates captured in the water of the reservoir will settle out and saturate the bottom of the reservoir, while the upper level of the reservoir water will be relatively free of contaminates. The contaminants will cover the vibrating surface of the transducer and after periods of inactivity, the contaminants will adhere to the transducer, thereby lowering its efficiency. The oils and oil byproducts in the repellent further bind the contaminants to any metal surfaces present in the well, such as the transducer diaphragm.

This problem is partially overcome in the present invention by providing a sump below the level of the vibrating surface of the transducer. Turning again to FIGS. 6A and 6B, the depth of the water column above the vibrating surface of the transducer is shown as h₁ and h₂, depending on the level of water in the well. Sump distance, shown as h₄, is typically only a few millimeters in prior art humidifiers, perhaps up to 0.25 in. In accordance with an exemplary embodiment of the present invention, the depth of sump 133 h₄ is deepened to create a low energy environment conducive to holding contaminates. In the present invention, sump depth h₄ may exceed 1.0 in. depending on the air velocity and the type and concentration of contaminates in the air. While the bottom of the sump 133 in well 132 must be cleaned from time to time, the cleaning frequency is much less than the maintenance cycle of the ultrasonic transducer.

The second solution to contaminates, and for anything that might stick to the vibrating surface of ultrasonic transducer assembly 134, is to select a nonstick surface that does not inhibit the transfer of ultrasonic energy to the repellent or causes heat to accumulate in the piezoelectric crystal of the transducer. Turning now to FIG. 8A, ultrasonic transducer assembly 134 is shown in accordance with an exemplary embodiment of the present invention. Ultrasonic transducers take many forms, but the exemplary transducer comprises mounting case 175 with a flanged opening for securely holding the transducer in place. Mounting case 175 is secured to the bottom of well 132 by fasteners with seal/o-ring 180 there between. The transducer comprises piezoelectric crystal 178 that converts electrical energy to high frequency mechanical energy (inaudible sound) and is usually silver soldered to a pair of electrical leads. Piezoelectric crystal 178 is not usually exposed to the water in humidifiers but is separated by metal disc 177 (the disc may be of any shape and in some applications a screen is substituted for a solid disc). The disc may actually be in the form of a cap or encase the entire piezoelectric crystal. The energy created by piezoelectric crystal 178 vibrates metal disc 177, causing the water to cavitate. Piezoelectric crystal 178 and metal disc 177 are held securely by UL approved transducer seal 176 that surrounds the opening in mounting case 175. Metal disc 177 is typically fabricated from stainless steel, nickel plated or layered steel, or titanium. In either case, the oils and oil byproducts of the repellent readily adhere to the surface of metal disc 177 and its efficiency rapidly degrades. It appears that the metal surface attracts the oils and/or repels the surfactant in the repellent, resulting in an oil residue on the metal. The oil residue can usually be cleaned, but adds another maintenance item for the user. Oil mixed with airborne contaminants, and biological material is far more stubborn to clean. Often, the most expeditious solution is to simply replace the entire ultrasonic transducer assembly 134, thereby greatly increasing the cost of operation of the unit. In accordance with an exemplary embodiment of the present invention, piezoelectric crystal 178 is separated from repellent 121 by ceramic disc 179 rather than the metal jacket. The repellent oils and oil byproducts are not attracted to the ceramic material in the manner of the metal disc and the surface of the ceramic disc remains pristine longer. Contaminants and particulate matter that does settle on ceramic disc 179 does not adhere to the ceramic to the extent as with the metal. In most cases, any oil residue that is present can usually be brushed off of the surface of ceramic disc 179 without replacing it. Metal disc 177 may be interposed between piezoelectric crystal 178 and ceramic disc 179 without any loss of efficiency. Therefore, in accordance with still another exemplary embodiment of the present invention, ceramic disc 179 may be separately replicable from piezoelectric crystal 178. In that case, ceramic disc 179 may be separately cleaned or replaced without disturbing ultrasonic transducer assembly 134 and without incurring the costs.

As mentioned elsewhere above, during operation ultrasonic transducer assembly 134 forms a water cone that tends to induce the formation of larger sized particle droplets. The force of the forced air from blower 140 sweeps these large repellent droplets into the exhaust duct 186 and out of the machine causing a spray of repellent. Aside from using a diverter in the duct, ultrasonic transducer assembly 134 can be oriented for maximum vapor product with a minimally sized water cone. Cavitation efficiency is severely decreased as angle θ diverges from horizontal. On the other hand, the size of the water cone in the air stream can be decreased by increasing angle θ in the direction of the air stream, see FIG. 8B. With the water cone oriented away from the air stream, less repellent is spattered and drawn up into the duct as large sized droplets. Decreasing angle θ in the direction of the air stream tends to build the water column like an offshore breeze causes ocean waves to build, see FIG. 8C. Not only is the water column taller with more surface area for creating larger droplets, but it presents a larger obstacle to the air stream that induces a low pressure zone on the backside of the water cone that is further conducive for droplet formation. Therefore, piezoelectric crystal 178 and ceramic disc 179 should be oriented slightly in the direction of the air flow, thereby reducing the size of the water cone. Optimally, angle θ should be between 5.0 and 9.0 degrees, preferably around 7.0 degrees off horizontal.

Another advantage of the present ultrasonic repellent humidifier is its portability. Ultrasonic repellent humidifier 100 can be repositioned to various locations on the user's property depending on the need for repelling insects. In accordance with some aspects of the present invention, the device is battery powered, thereby further increasing portability. Portability is further realized in a lighter, more compact ultrasonic repellent humidifier that can be conveniently carried to events such as picnics, tailgating, camping, fishing, golfing, the beach, hiking, woodlands, outdoor concerts, plays, recitals and staged events and spectator sports. Optimally, the ultrasonic repellent humidifier is light, durable, energy efficient, battery powered and adaptable to a variety of power sources, while achieving vaporization of significant quantities of repellant.

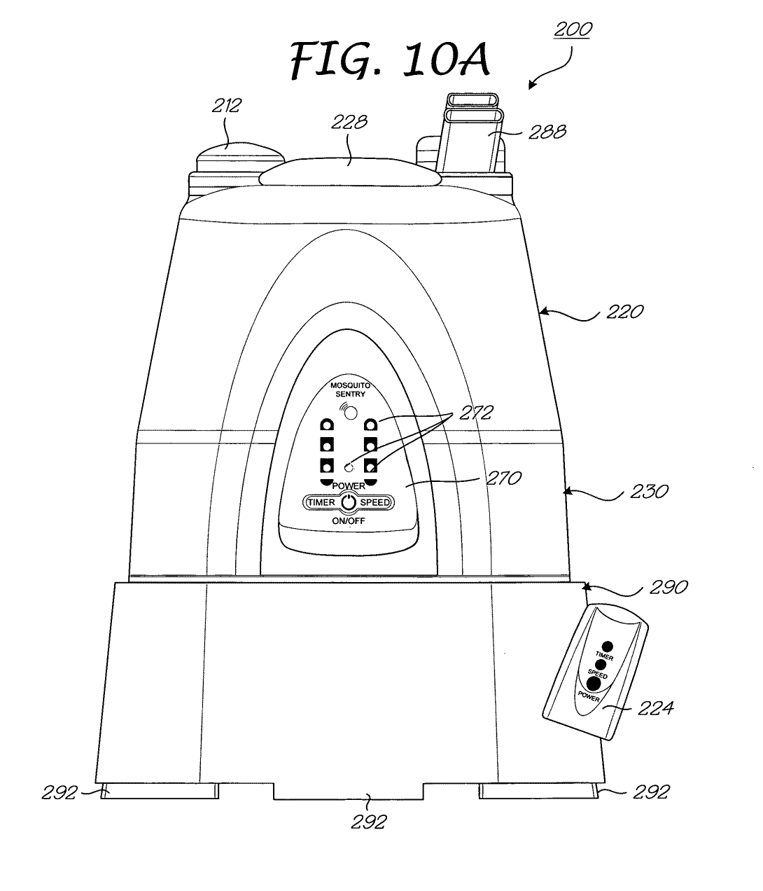

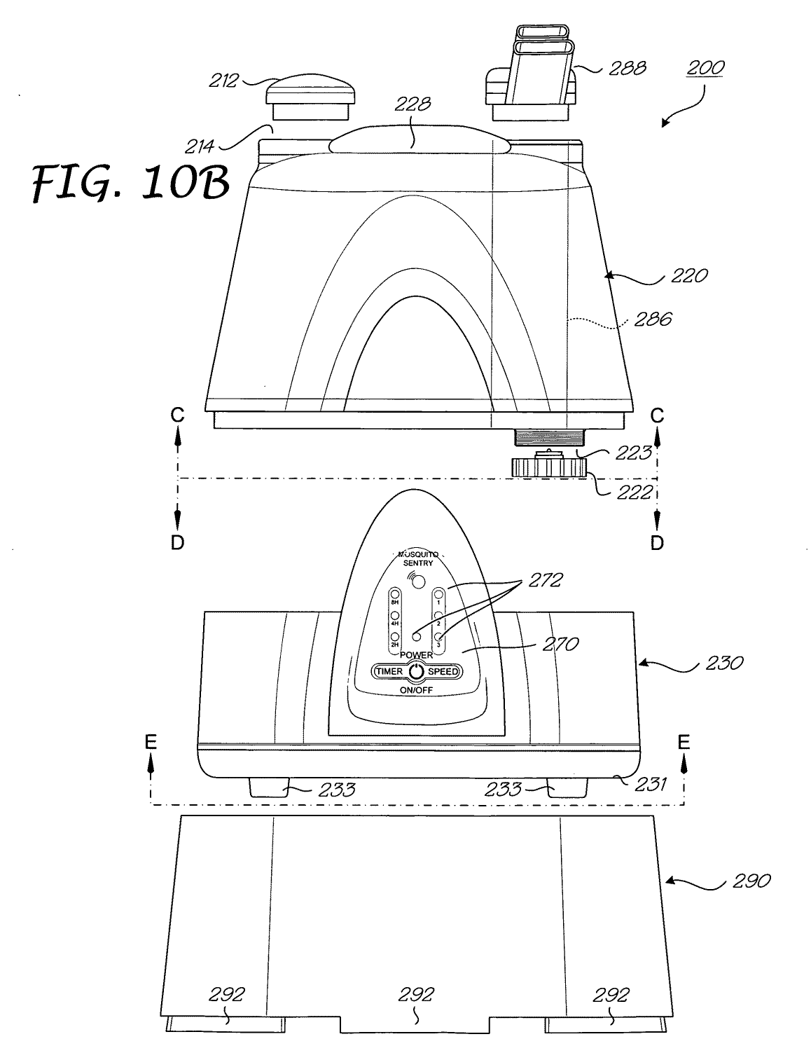

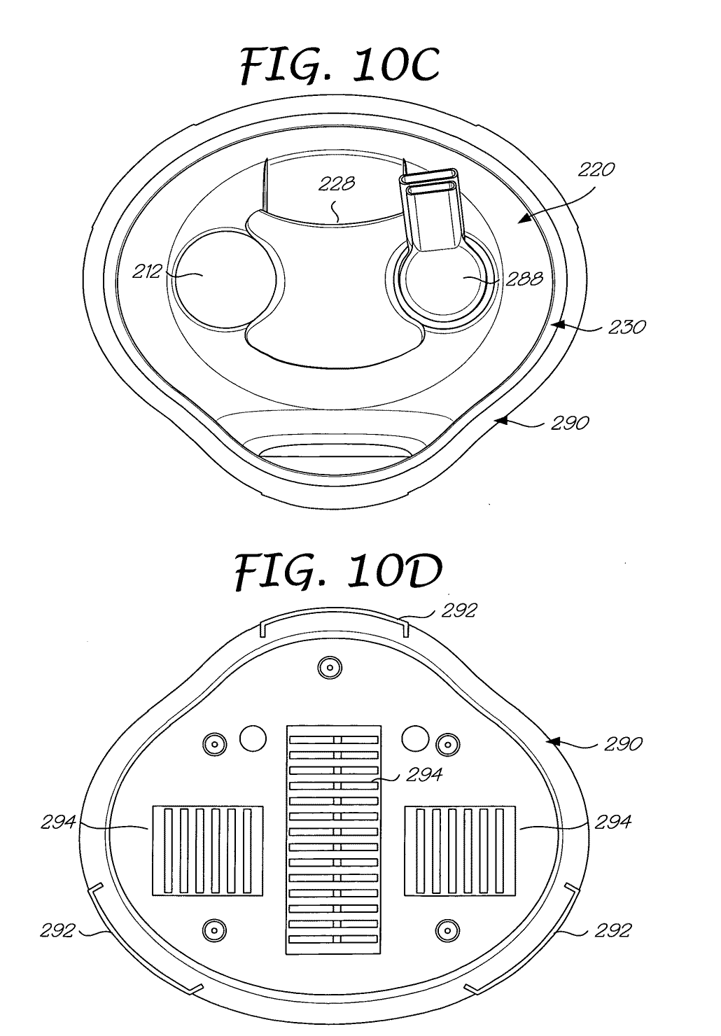

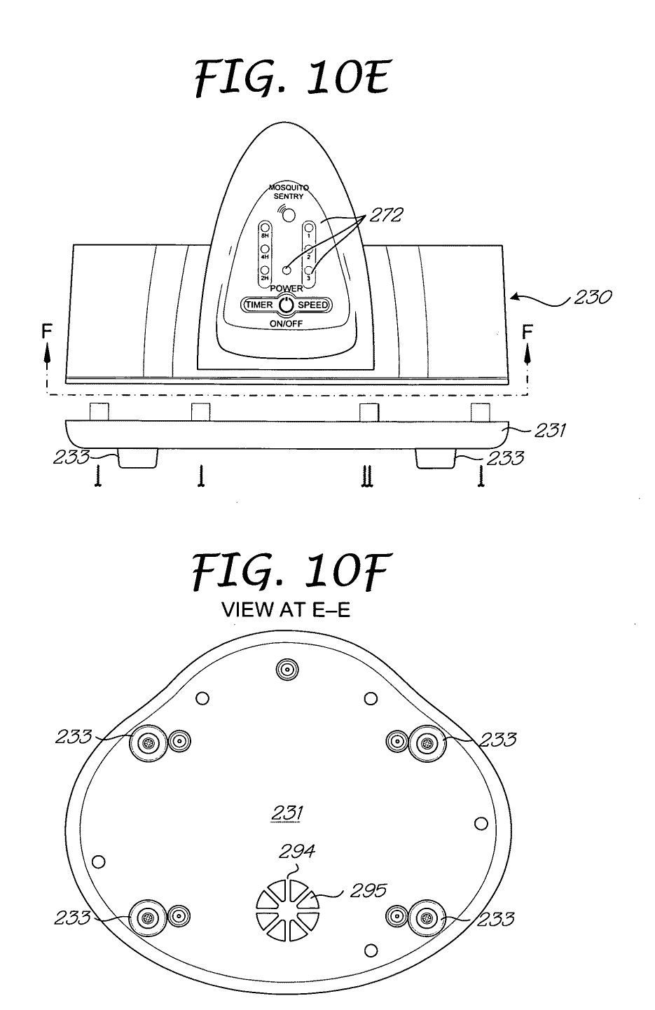

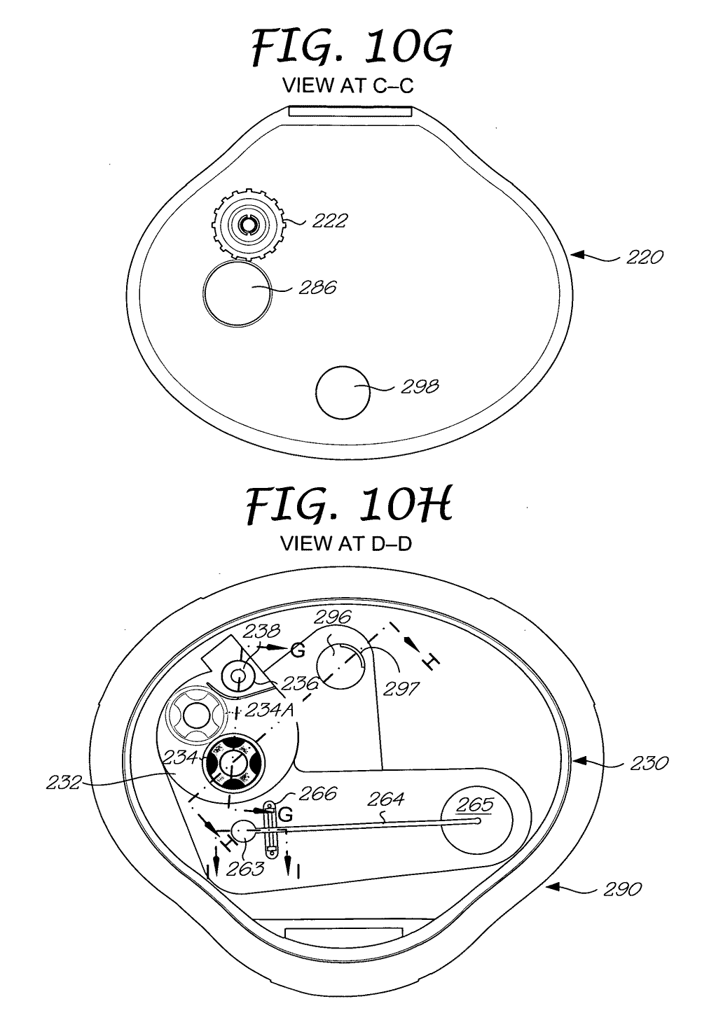

FIGS. 10A, 10B, 10C, 10D, 10E, 10F, 10G, 10H and 10I are diagrams of various views of an improved ultrasonic repellent humidifier for reducing catastrophic electrical failures in accordance with other exemplary embodiments of the present invention. FIG. 10A depicts a front view of improved ultrasonic repellent humidifier 200 and FIG. 10B depicts an expanding front view of the individual sections. Ultrasonic repellent humidifier 200 generally comprises tank section 220, humidifier or nebulizer section 230 and base or stand section 290 and optional remote control 224. Typically, ultrasonic repellent humidifier 200 is a larger unit intended for use as a cabinet or floor model resting on legs 292 on the ground level, hence optional stand section 290 may be employed to elevate ultrasonic repellent humidifier 200 several or more inches above ground level. Alternatively, as depicted in FIG. 10B, stand section 290 may be omitted and the unit positioned for use on feet 292 of nebulizer section 230. In so doing, the size and weight of ultrasonic repellent humidifier 200 is reduced sufficiently for table-top or cabinet-top positioning.

As mentioned, the purpose of optional stand section 290 is to elevate tank section 220 and humidifier section 230 such that adjustable vapor vents/register 288 is high enough for the repellant vapor to propagate into the upper strata of a room. Optional stand section 290 securely receives and couples with humidifier section 230 using fasteners or a latching mechanism (not shown). In accordance with one exemplary embodiment of the present invention, humidifier section 230 contains all of the electric and electrical components employed by ultrasonic repellent humidifier 200. User control for the electronic components is disposed on control panel 270 with panel input buttons/switches 272 (for instance, sealed membrane-type switches) and accompanying status lights (LEDs). Operationally, humidifier section 230 draws air through air vents 294 in nebulizer base 231 (see FIG. 10F) and, optionally, through the bottom of optional stand section 290 (see FIG. 10D) and into fan assembly 240, which propels the air from below humidifier section 230 and across repellant well 232 and mixes with repellant vapor produced by any of ultrasonic transducer assembly 234 and/or optional ultrasonic transducer assembly 234A, which is then forced into vapor duct 286 through tank section 220, and across and out adjustable vapor vents/register 288. Hence, tank section 220 provides two separate functions. First, tank section 220 provides a repellant reservoir or tank for holding repellant prior to dispensing into repellant well 232 and it also provides an air conduit, vapor duct 286, between humidifier section 230 and adjustable vapor vents/register 288. As may be appreciated from the upper view of ultrasonic repellent humidifier 200 depicted in FIG. 10C, tank section 220 also provides a means for replenishing the liquid repellant in the tank, via tank fill cap 212 and tank handle 228 for repositioning ultrasonic repellent humidifier 200, in addition to at least one adjustable/repositionable vapor vent/register 228.

Operationally, liquid repellant is retained in tank section 220 until the repellant level of repellant well 232 is sufficiently low to accommodate additional liquid repellant. This is accomplished using a tank valve and well float assembly similar, though not identical, to that discussed above with regard to FIGS. 6A and 6B. As an aside, some of the features of ultrasonic repellent humidifier 200 are similar to that discussed above with regard to ultrasonic repellent humidifier 100, and therefore, only the differences, distinctions and improvements will be elaborated on in this discussion. In accordance with exemplary embodiments of the present invention, tank valve 222 is disposed on a threaded fitting forming tank opening 223 located on the bottom of tank section 220. Tank valve 222 comprises threaded tank valve body 229 that further provides a sealing surface for and supports normally-closed seal 225, which is movably secured in tank valve body 229 through tank valve shaft 227 and biased against the sealing surface by tank valve spring 226 (see FIGS. 10B, 12A and 12B). Importantly, tank valve spring 226 is the only metallic composition that comes in contact with the liquid repellant, thereby lowering the risk of harmful reactions with the repellant. Optimally, tank valve spring 226 should be comprised of a non-reactive metal such as stainless steel. Here, the reliance on a metallic spring may be justified over using rubber or synthetic materials as a biasing member that may lose their flexibility with prolonged exposure to the liquid repellant. Alternatively, tank valve spring 226 may be comprised of plastic, ABS or PVC rather than metal which may remain flexible much longer than rubber compounds.

As discussed above, tank valve 222 is actuated between the valve open and valve closed positions by contact with well float contact 263 portion of well float assembly 264 (see FIGS. 12A and 12B). As also described, well float assembly 264 is pivotally mounted above repellant well 232, well assembly pedestal 266 which provides an axel between well float contact 263 and well float 265 on well float assembly 264, thereby enabling the height of well float 265 to move with the level of liquid repellant in repellant well 232 and well float contact 263, proportionally but in the opposite direction as the float.

With further regard to humidifier section 230, FIG. 10H depicts a view of the top side of humidifier section 230 at line D-D from FIG. 10B, while FIG. 10I shows a view of the bottom side of humidifier section 230 at line F-F. Here it should be appreciated that in accordance with exemplary embodiments of the present invention, humidifier section 230 is designed to isolate the electronic and electrical components affixed to the bottom of humidifier section 230 from the repellant within the volume between the top side of humidifier section 230 and tank section 220, whether that repellant is in liquid or vapor form. The electrical components include, but are not limited to, fan assembly 240, well level switch assembly 236, ultrasonic transducer assembly 234 and optional ultrasonic transducer assembly 234A, transducer driver circuit(s) 262, tilt (shut off) switch 248, control panel circuit board 274, power port 252 (with accompanying power jack 251 and power adapter 492C, for instance 110VAC/36VAC), various wires, conductors and wiring between electrical components and one or more optional batteries 246 with rectifier circuitry (not shown). In the presence of repellant, in liquid or vapor form, each of these components becomes a liability to the longevity of the humidifier.

Optimally, the aim is to construct the components located on the upper side of humidifier section 230 (depicted in FIG. 10H) in such a way that there are no electronics or electrical components exposed to the repellant (liquid or vapor) and that now passages exist between the upper side of humidifier section 230 and the lower side of humidifier section 230 that houses the electronics. Although not completely necessary for isolating the electronics below humidifier section 230, and optional seal may be installed between humidifier section 230 and tank section 220 to prevent the leakage of liquid repellant while the humidifier is in transit or in case the unit is tilted.

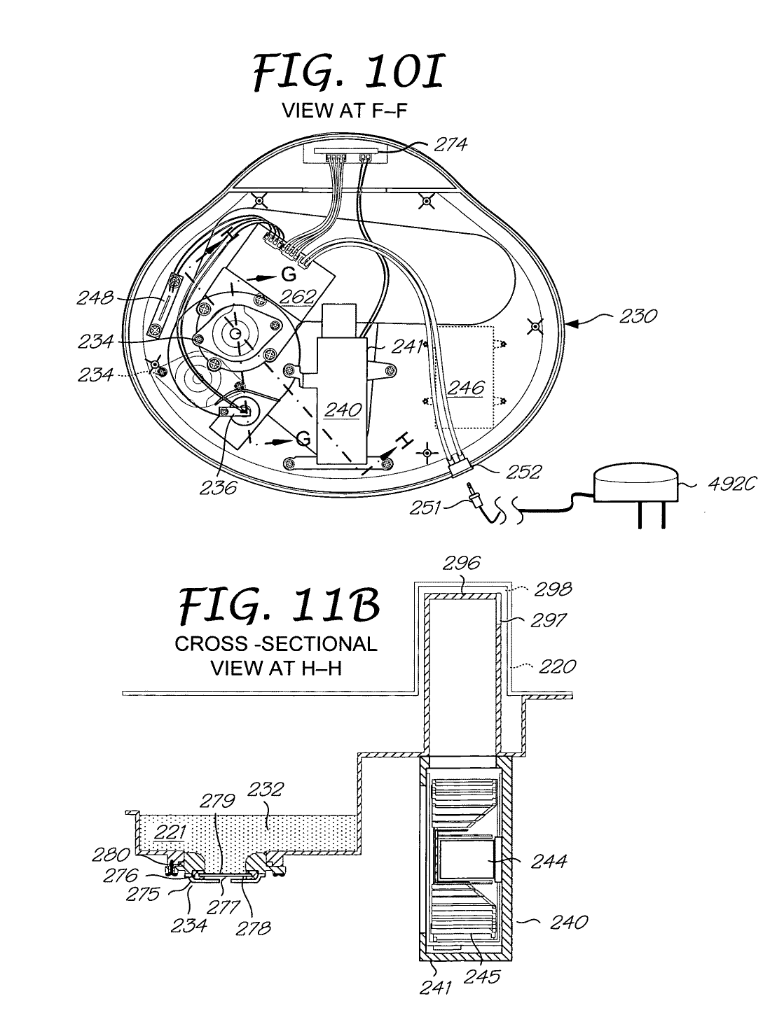

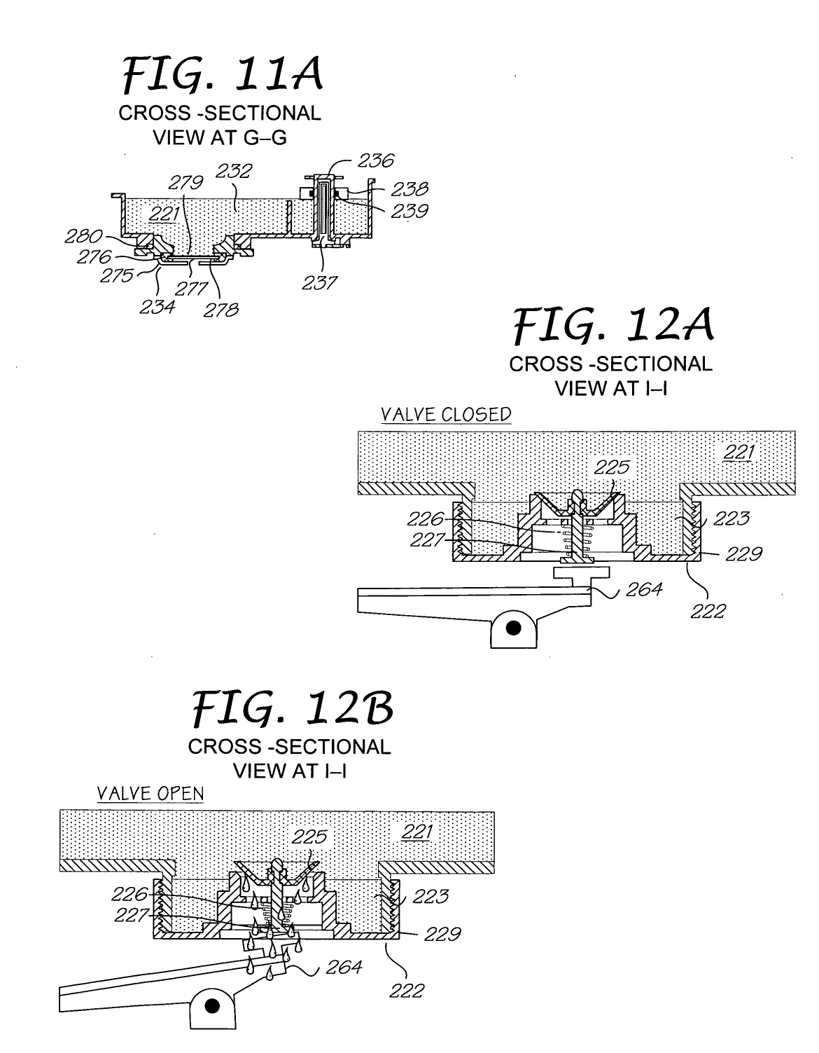

One component that must be exposed to the repellant for the humidifier to operate is the transducer. As may be appreciated from the diagrams depicted in FIGS. 10H, 10I, 11A and 11B, transducer 278 is supported on the bottom side of humidifier section 230 within ultrasonic transducer assembly 234 (and 234A) and in transducer seal 276 by transducer case 275 and at an opening in the lower surface of humidifier section 230 to repellant well 232. Electrical conductors are coupled between metal disk 277 and transducer driver circuit 262, with metal disk 277 surrounded laterally by transducer seal 276, and with ceramic cover 279 interposed between the upper surface of metal disk 277 and the opening to repellant well 232, which is likewise surrounded laterally by transducer seal 276. Thereby, isolating transducer 278 from the repellant in repellant well 232 with ceramic cover 279, and further isolating the electronic and electrical components of humidifier section 230 with transducer seal 276.

One electrical component that is essential to the proper operation of the repellant humidifier and that has been prone to excessive failure in the prior art is the well level sensor and/or switch. Typically, the well level sensor known in the prior art operates by sensing the presence of liquid in repellant well 232. Hence, at least the sensor portion and sometimes the sensor and switch are exposed to the liquid in the well. While this may constitute an acceptable risk for water vapor humidifiers, exposure to liquid repellant compositions, in addition to airborne contaminates deposited in the well, make this type of sensor prone to failure. The causes usually relate to the electrical conductance of the repellant and/or contaminates in the well, or simply a film of scale or contaminates that covers the sensor and inhibits its operation. In accordance with one exemplary embodiment of the present invention, well level switch assembly 236 is disclosed that overcomes the shortcoming of the prior art by insulating the sensitive electrical components from the repellant while simultaneously, elevating components that do come in contact with the repellant from the bottom of the repellant well to the top of the repellant level in repellant well 232. This is accomplished through the use of a magnetically actuated reed (or comparable) switch, where electrical well level sensor 237 is encapsulated within hollow pedestal 235, which isolates electrical well level sensor 237 from the repellant while sensing the vertical proximity to magnetic ring 239 that is disposed on well level switch float 238 (see FIGS. 10H and 10I and cross-sectional view in FIG. 11A). Here, cylindrically shaped well level switch float 238 supports magnetic ring 239 about the exterior of encapsulated hollow pedestal 235 and the pair float on the surface of the repellant in repellant well 232. As the level of the repellant changes, the vertical positions of well level switch float 238 and magnetic ring 239 also change. As (or if) the repellant level in repellant well 232 drops below a predetermined level, electrical well level sensor 237 senses that increase in the magnetic field from the position of magnetic ring 239 and actuates a switch in electrical well level sensor 237, which signals control panel circuit board 274 of a low fluid level which, in turn, de-energizes transducer(s) 278. Control panel circuit board 274 may also issue an audible and/or visual alert to the low repellant level in repellant well 232.

As might also be appreciated from the foregoing, it is impossible to completely isolate the electronics and electrical components in humidifier section 230 from the liquid repellant and repellant vapor because an open air passage must exist between fan assembly 240, in humidifier section 230, and adjustable vapor vents/register 288. During and between operating intervals, the denser repellant vapor that is not caught in the air flow from the exhaust fan will settle to the lowest level of the humidifier that is accessible to the vapor. This problem is most pronounced in the time period immediately after a vapor cycle when the fan stops. Then, the dense vapors settle at the lowest point in humidifier section 230 that is accessible to the vapor, but because the air flow has ceased, the vapor is not inhibited by the stream of air and may enter the exhaust fan directly and into humidifier section 230. One option is to de-energize the transducer(s) before the fan, thereby enabling the denser repellant vapor in the air stream to be vented from the machine. This is not a practical option because most users expect the humidifier to cease operating immediately once it is switched OFF. Additionally, and at best, this solution is only partial as the repellant and repellant vapor not in the air stream will condensate and seek the lowest point, which may be the exhaust fan and directly to the electronics and electrical components of humidifier section 230. Another option is to mount the exhaust fan above humidifier section 230 and duct its inlet directly to the exterior of ultrasonic repellent humidifier 200. This solution protects the electronics and electrical components in humidifier section 230 from repellant and repellant vapor, but not the exhaust fan. Furthermore, the electronics and electrical components in humidifier section 230 may require a separate fan for cooling, thereby increasing materials and operations costs without isolating the exhaust fan from the repellant.

Therefore, in consideration of the foregoing and in accordance with another exemplary embodiment of the present invention, the exhaust fan is vented to the upper side of humidifier section 230 through an elevated snorkel air vent that prevents the denser (and therefore heavier) repellant vapor from entering the bottom side of humidifier section 230 through the exhaust fan. With regard to FIGS. 10H and 11B and with reference to FIG. 10G, the present construction and operation of elevated snorkel air vent 296 will be discussed. In accordance with one exemplary embodiment of the present invention, elevated snorkel air vent 296 comprises a vertical air conduit with an opening to the upper side of humidifier section 230 at or near the uppermost extent of the conduit and a second opening at the lowermost end of the conduit which is further sealed-coupled to the air exhaust of fan assembly 240. In so doing, the denser and heavier repellant vapor generally remains below the opening at the upper end of elevated snorkel air vent 296. Elevated snorkel air vent 296 may be of any vertical height that can be accommodated by tank section 220, but as a practical matter, vertical elevation over a few inches in height produce only moderate results while being particularly difficult to accommodate. In accordance with another exemplary embodiment, disposed along elevated snorkel air vent 296 is a side mounted vent opening 297. Here, rather than being exposed to vapor and condensation from above, the vertical extent of elevated snorkel air vent 296 is capped and vent opening 297 is positioned literately on snorkel air vent 296 near the top. Optimally, the area of vent opening 297 should be approximately equivalent to the area of the outlet or exhaust or port of fan assembly 240, but as a practical matter may have as little as half the area of the fan's outlet without any substantial reduction in the air flow. Additionally, vent opening 297 disposed on the lateral side of elevated snorkel air vent 296 is oriented on a side that is away from or ultrasonic transducer 234 (and 234A) or on the opposite side of elevated snorkel air vent 296 to the transducer(s). This orientation of vent opening 297 eliminates or greatly reduces the amount of repellant spatter from ultrasonic transducer 234 (and 234A), that enters air vent 296. In accordance with yet still another exemplary embodiment of the present invention, elevated snorkel air vent 296 is surrounded by snorkel recess 298 formed in the bottom surface of tank section 220 (see FIG. 10G). Optimally, the annular space formed between snorkel air vent 296 and snorkel recess 298 should be sufficiently large not to restrict the air flow into the area over repellant well 232 and into vapor duct 286, typically less than 0.25 inch annular distance will suffice, see, for instance, FIG. 10G.

Aside from the cabinet or floor model of repellant humidifiers described above, the features of the presently described invention can readily be incorporated in portable repellant humidifier variants without departing from the scope and spirit of the present invention.

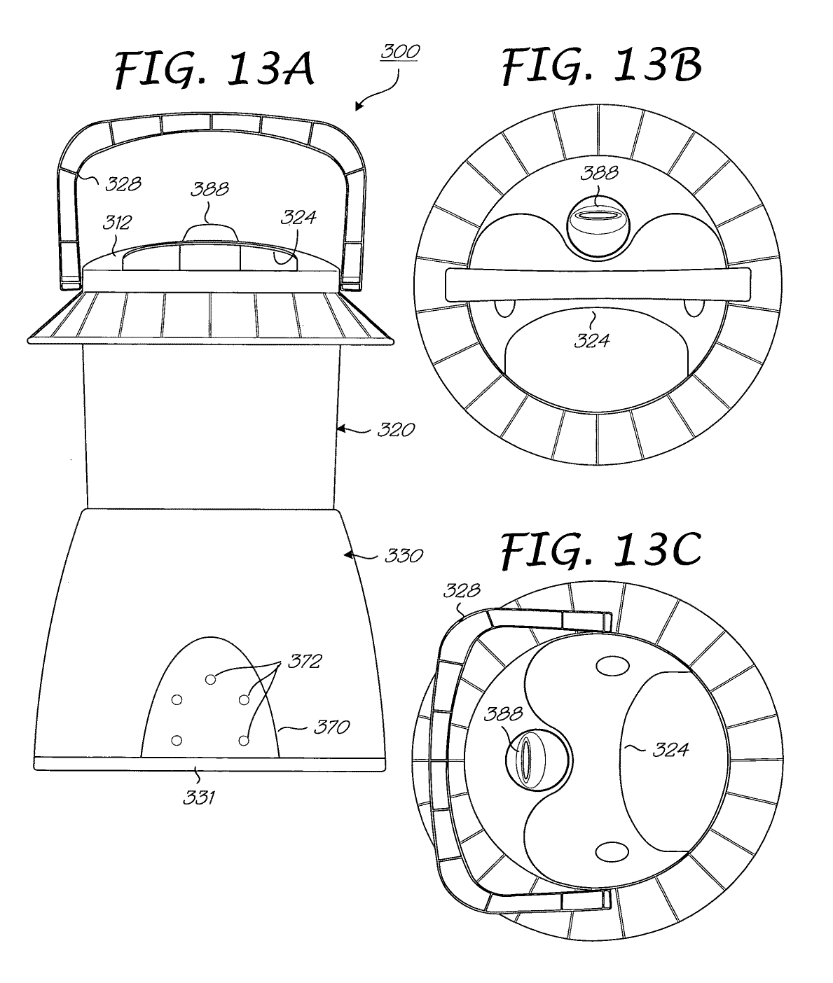

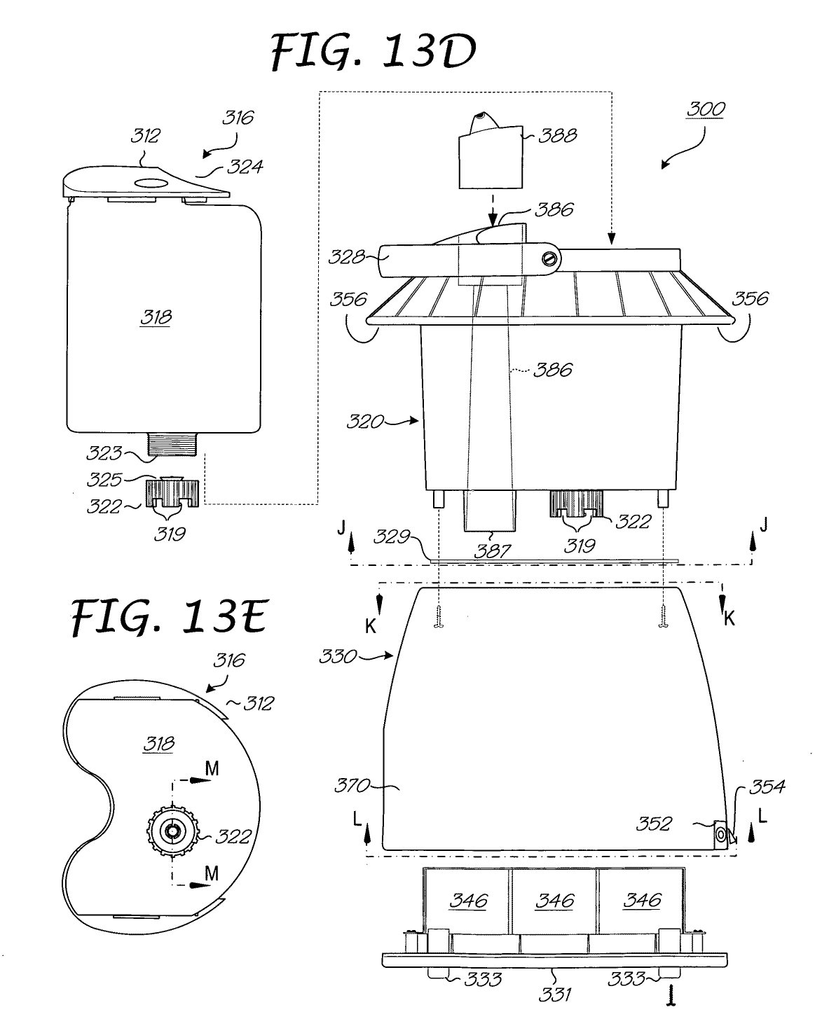

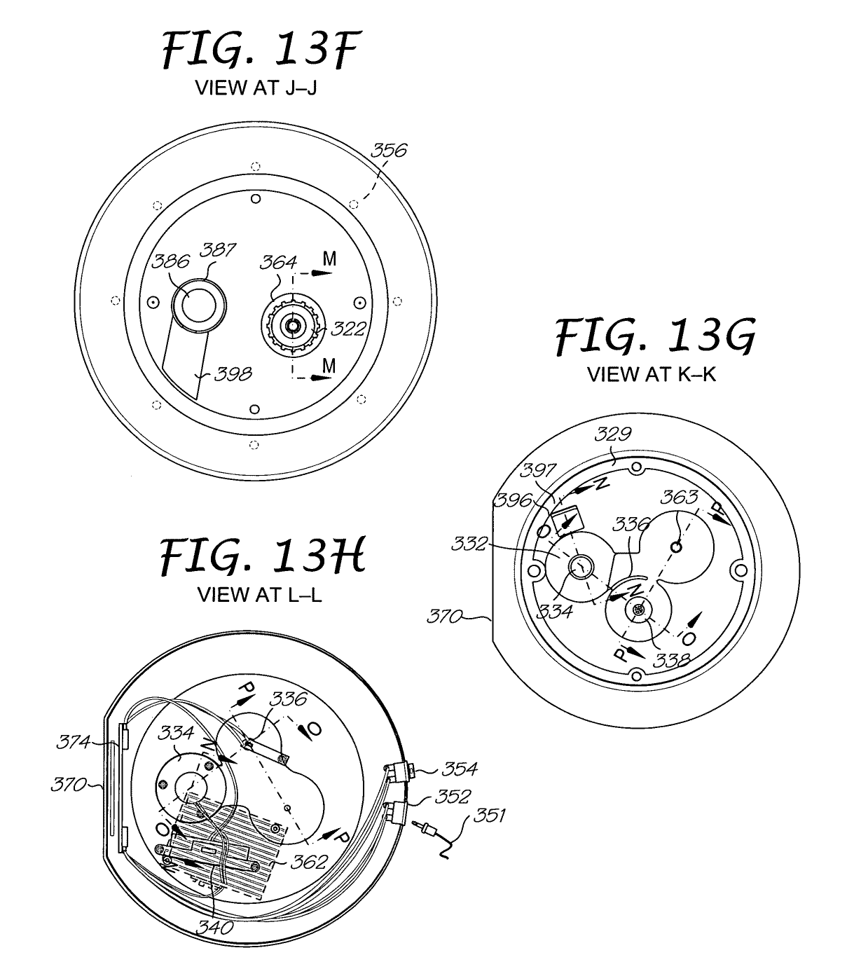

FIGS. 13A, 13B, 13C, 13D, 13E, 13F, 13G and 13H are diagrams of various views of an improved portable ultrasonic repellent humidifier for reducing catastrophic electrical failures in accordance with other exemplary embodiments of the present invention. Some aspects of the improved portable ultrasonic repellent humidifier 300 are similar to those discussed immediately above with regard to improved ultrasonic repellent humidifier 200, therefore the differences, distinctions and improvements will be highlighted in the discussion below. FIG. 13A depicts a front view of improved portable ultrasonic repellent humidifier 300 which generally comprises tank section 320 and humidifier or nebulizer section 330. Because ultrasonic repellent humidifier 300 is a portable unit, it is expected that the unit can be elevated by hanging the unit by humidifier handle 328 rather than elevating the unit with a base or stand section as described above. Externally on the front of portable ultrasonic repellent humidifier 300 is disposed control panel 370 with panel input buttons/switches 372 (for instance, sealed membrane-type switches) and accompanying status lights (LEDs). FIGS. 13B and 13C show the top view of portable ultrasonic repellent humidifier 300 (front and side orientations) with humidifier handle 328 in the upright position (FIG. 13B and folded position FIG. 13C). Portable ultrasonic repellent humidifier 300 differs from ultrasonic repellent humidifier 200 in one way in that the repellant tank (removable repellant tank assembly 316) is removable from tank section 320 for refilling with repellant, which will be discussed below (see FIGS. 13D and 13E).

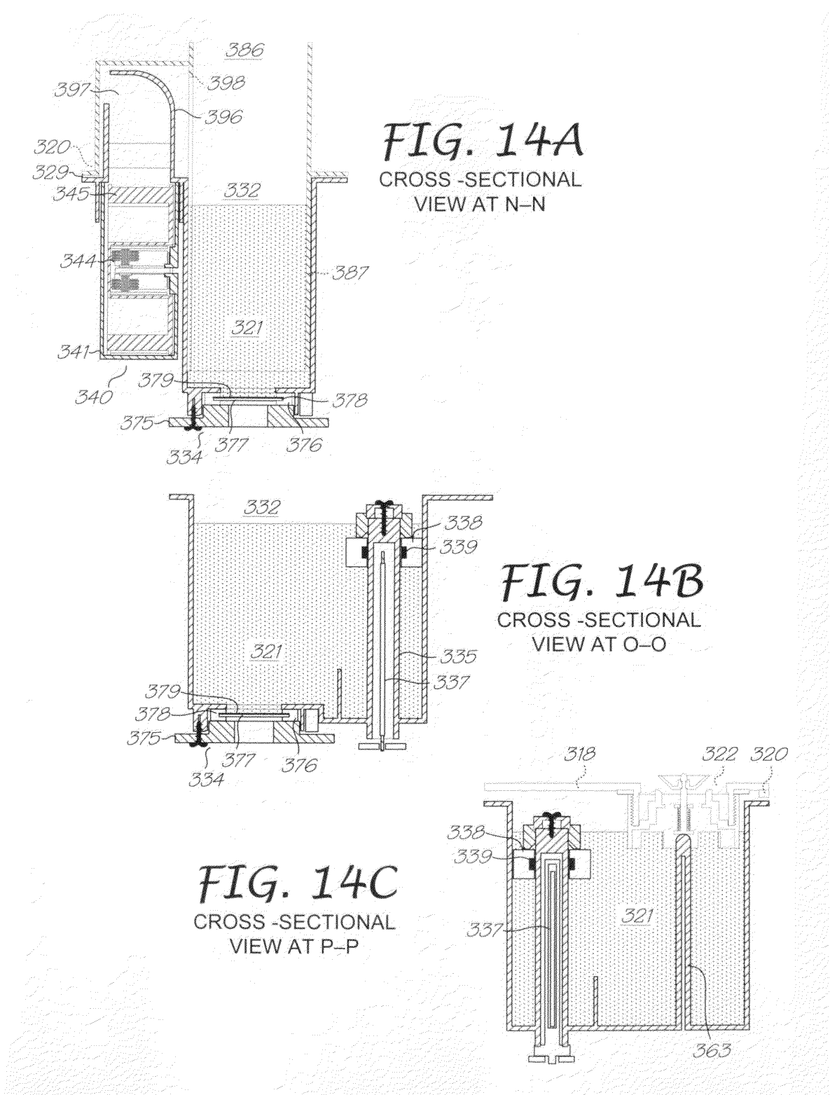

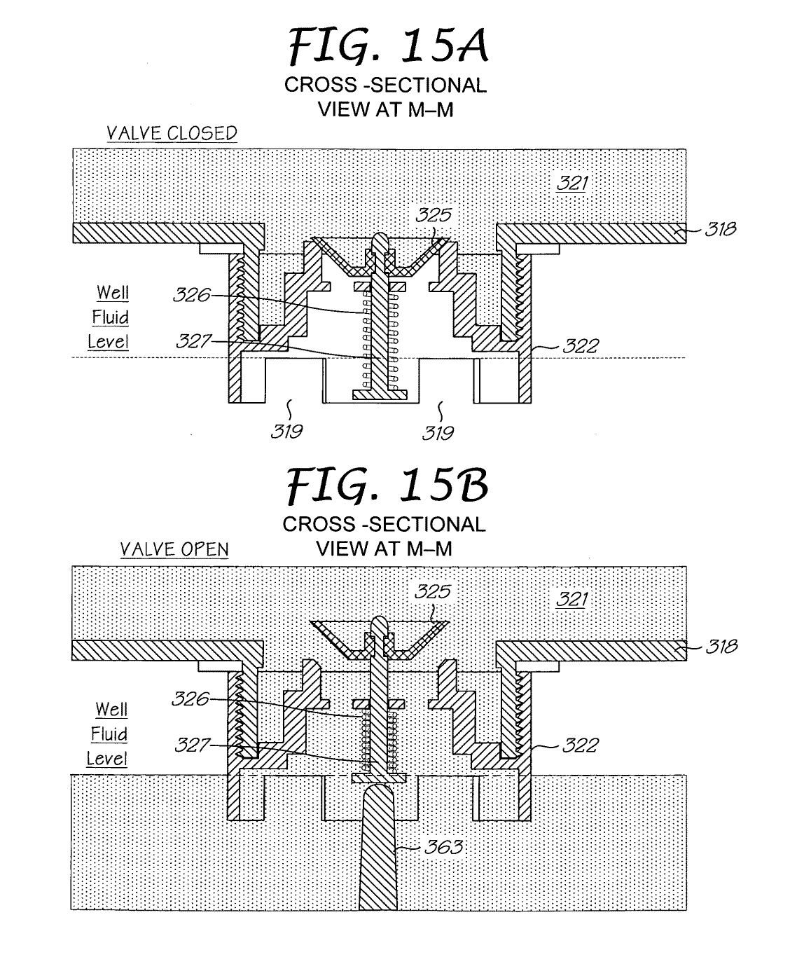

Returning to the top view, adjustable vapor vents/register 388 is located adjacent to tank cover 312 that forms tank handle 324 opposite of adjustable vapor vents/register 388 (see FIGS. 13D and 13E) and over vapor duct 386 that provides a conduit to nebulizer section 330 (see FIGS. 13D, 13F and 14A). Removable repellant tank assembly 316 generally comprises tank cover 312 disposed on and attached to tank 318, which has a single threaded opening 323 located at the bottom for receiving threaded tank valve 322. Unlike the previous embodiments, portable ultrasonic repellent humidifier 300 makes use of an un-vented and removable repellant tank that is refilled through tank opening 323 by inverting the tank and removing tank valve 322. Once filled, removable repellant tank assembly 316 is lowered into tank section 320 where static valve actuator contact 363 portion of nebulizer section 330 actuates tank valve 322 (see FIG. 13G and cross-sectional diagram FIG. 14C). Tank valve 322 is similar to valve 222 comprising threaded tank valve body 329 with a sealing surface for cooperating with normally-closed seal 325 that is held centered in tank valve body 329 by tank valve shaft 327. Tension for biasing normally-closed seal 325 against the sealing surface is provided by tank valve spring 326 (see FIGS. 13F, 14B, 15A and 15B). Tank valve 322 differs from tank valve 222 in that tank 318 is un-vented. Therefore, air replacing the repellant is vented from opening un-vented and removable repellant tank 316 through tank valve 322. With further regard to FIGS. 15A and 15B, tank valve air inlets 319 are provided across the lower surface of tank valve 322. These gaps allow air to egress tank 318 while repellant escapes the tank and fills repellant well 332. When the repellant level within repellant well 332 drops below the level of tank valve air inlets 319, air is siphoned into tank 318 and repellant is expelled.

As discussed with regard to the embodiment of ultrasonic repellent humidifier 200, leakage of repellant into the electronics and electrical components within nebulizer section 330 is unwanted as it substantially shortens the life of the humidifier, which is not usually a problem with water-type humidifiers. Therefore, in accordance with another exemplary embodiment of the present invention, fan assembly 340 is positioned directly below an elevated conduit that extends well above the level of repellant 321 in repellant well 332 as depicted in FIGS. 13G and cross-sectional diagram 14A. The exhaust fan is vented to the upper side of humidifier section 330 through elevated snorkel air vent 396 that prevents the repellant laden air from entering the lower bowels of humidifier section 330 and hence in contact with the electronics and electrical components within. Elevated snorkel air vent 396 may be fabricated as an integrated part of humidifier section 330, thereby eliminating any leakage in seams between snorkel air vent 396 and humidifier section 330. In any case, elevated snorkel air vent 396 generally comprises a vertical air conduit with an opening to the upper side of humidifier section 330 near the top of the conduit and a second opening that exposes the bottom side of humidifier section 330. At the lower end, snorkel air vent 396 is coupled to the air exhaust of fan assembly 340. As discussed above, the upper opening may be located at the top of snorkel air vent 396, however, it is advantageous to position vent opening 397 on a side wall of the conduit. In so doing, most vapor and condensation above snorkel air vent 396 will not enter the lower portion of humidifier section 330, but fall to the side of snorkel air vent 396 and eventually drain into repellant well 332. Optimally, vent opening 397 should be oriented away from or on the opposite side of snorkel air vent 396 from ultrasonic transducer assembly 324 in order to eliminate repellant spatter directly into vent opening 397. Finally, to eliminate any repellant mist or spatter from entering humidifier section 330 through snorkel air vent 396, elevated snorkel air vent 396 is surrounded by snorkel recess 398, which is formed as a depression in the bottom surface of tank section 320 (see FIG. 13F and cross-sectional diagram 14A). Optimally, the annular formed between snorkel air vent 396 and snorkel recess 398 should be sufficiently large not to restrict the air flow into the area over repellant well 332 and into vapor duct 386, see, for instance, FIG. 14A.

Another shortcoming of prior art humidifiers is that an efficient ultrasonic transducer produces a considerable volume of vapor that “explodes” through fluid above the transducer as an expansion of vapor, mist and spatter droplets. As the heavier mist and droplets travel vertically up vapor duct 386, much of it falls back into repellant well 332 and is re-vaporized by the transducer. However, mist and spatter that is ejected laterally from the transducer has a much higher likelihood of entering nebulizer section 330 and interfering with the operation of the electronics therein. The configuration of elevated snorkel air vent 396 and snorkel recess 398 greatly reduces the amount of mist proximate to vent opening 397, however, an optimal solution is to completely shield snorkel air vent 396 from any repellant spatter. To that end, and in accordance with another exemplary embodiment of the present invention, vapor duct 386 extends below tank section 320 and into repellant well 332 as splash hood 387 that prevents mist and spatter from being ejected laterally from repellant well 332 and onto the upper surface of nebulizer section 330 or into vent opening 397 of snorkel air vent 396. This configuration diverts heavy repellant mist, droplets and spatter vertically up into vapor duct 386 (see FIGS. 13F and 14A). Because splash hood 387 extends below the repellant level in repellant well 332, a slit or opening is provided to allow air to enter from fan 340 and carry the repellant vapor up through vapor duct 386.

Finally, portable ultrasonic repellent humidifier 300 may be configured with sealed well level switch assembly 336 for insulating the sensitive electrical components from the repellant and repellant residue that accumulates at the bottom of repellant well 332. Here again, a magnetically actuated reed (or comparable) switch within electrical well level sensor 337 is encapsulated within hollow pedestal 335, which isolates electrical well level sensor 337 from repellant 321 while sensing the vertical proximity to magnetic ring 339 that is disposed on well level switch float 338, and slidably secured to hollow pedestal 335 (see FIGS. 13G, 13H and cross-sectional view in FIG. 14C). Cylindrically shaped well level switch float 338 supports magnetic ring 339 about the exterior of encapsulated hollow pedestal 335 and the pair float on the surface of repellant 321 in repellant well 332. As repellant level decreases without being replenished from repellant tank 318, well level sensor 337 senses the magnetic field produced by the position of magnetic ring 339 (and well level switch float 338). At some point, the intensity of the magnetic field exceeds the biasing tension of the reed switch in electrical well level sensor 337, which signals control panel circuit board 374 of a low fluid level which, in turn, de-energizes transducer(s) 378.

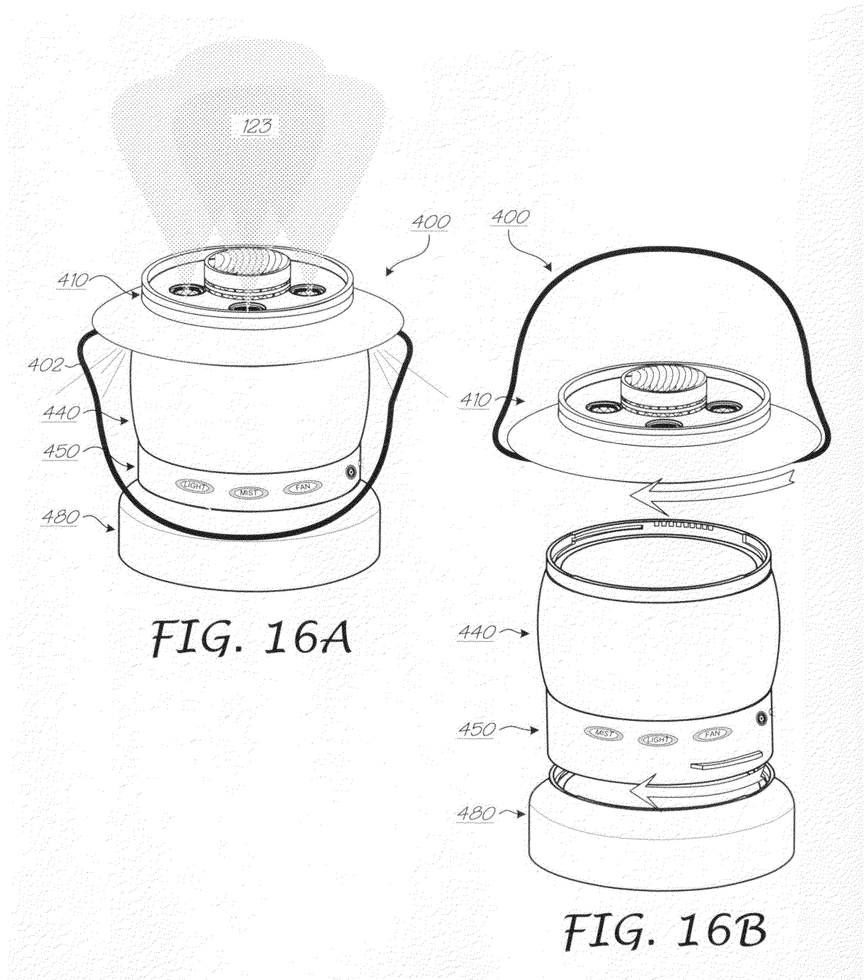

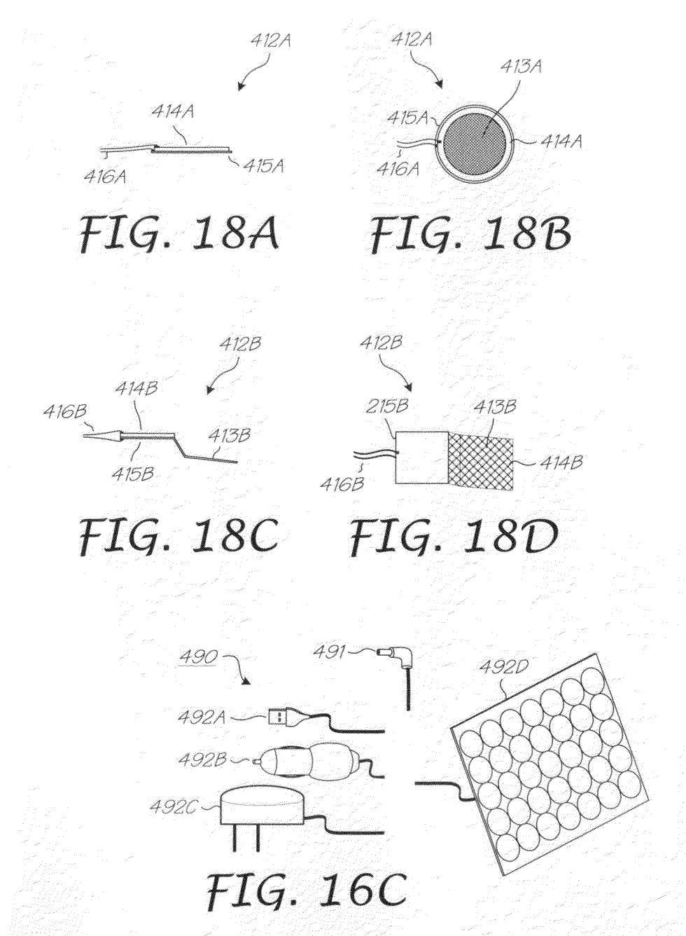

FIGS. 16A, 16B and 16C are diagrams of a portable ultrasonic repellent humidifier in accordance with exemplary embodiments of the present invention. Essentially, portable ultrasonic repellent humidifier 400 generally comprises four primary sections or assemblies: nebulizer assembly 410; tank assembly 440; control assembly 450 and base or battery assembly 480. It should be appreciated that while the shape of portable ultrasonic repellent humidifier 400 is suggestive of a lantern, its general proportions, dimensions and utility are highly adaptable for dispersing repellant vapors, i.e., compact size for easy placement on picnic tables, car roofs, tailgates, bleachers, turf, chairs, or wherever, a wide base to lessen tipping, a large interior volume for accommodating an adequate quantity of repellant, a handhold such as handle 402 for transporting and for securing repellent humidifier 400 to tree limbs, twine, canopies, etc., for higher vantage points, and an adaptable power source, such as a long life battery, and/or a universal power connection, that is a single power jack (power jack 491) adaptable to a variety of power sources, USB power adapter 492A, 12VDC car power adapter 492B; 110VAC power adapter 492C and regulated solar panel 492D. If battery powered, portable ultrasonic repellent humidifier 400 may utilize a variety of battery options, such a four, six or eight C- or D-cell disposable batteries, a rechargeable, sealed and maintenance free lead acid battery, such as RBCS, RBC9, RBC22, RBC32 or the like that are commonly used in UPC battery backup devices, rechargeable NI-CAD battery packs, such as are commonly used in portable power tools and even more expensive, but high performance and reliable, lithium ion battery packs. Optimally, portable ultrasonic repellent humidifier 400 operates in a voltage range between 4.4 volt and 14.0 volt to accommodate 4.4 volts from a USB port up to the 13.8 volts readily produced by “12V” lead acid batteries.

Additionally, because portable ultrasonic repellent humidifier 400 will not be used daily, it should be uncomplicated to operate and service. For instance, in accordance with one exemplary embodiment of the present invention, repellent humidifier 400 comprises as few as a single easily understood tactile button (optimally a plurality of buttons) and the repellant tank can be replenished by merely uncoupling nebulizer assembly 410 from tank assembly 440, thereby exposing the inner volume of the repellant tank. Spend batteries can be replaced in a similar fashion by uncoupling control assembly 450 from battery assembly 480, thereby exposing the battery compartment and batteries.

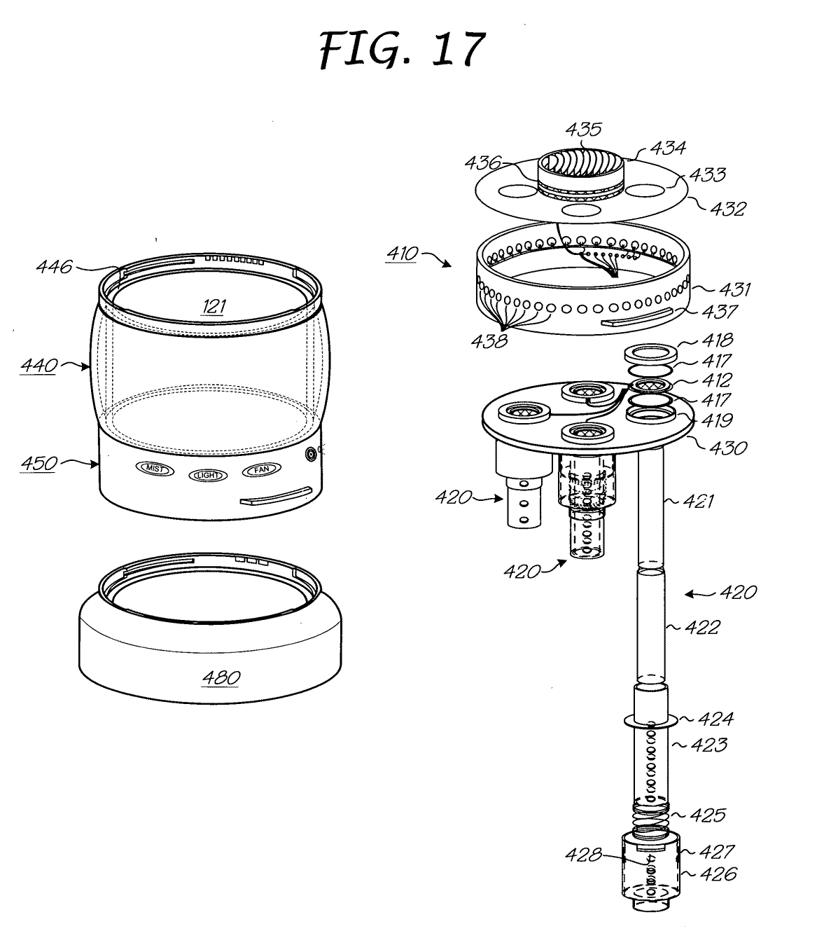

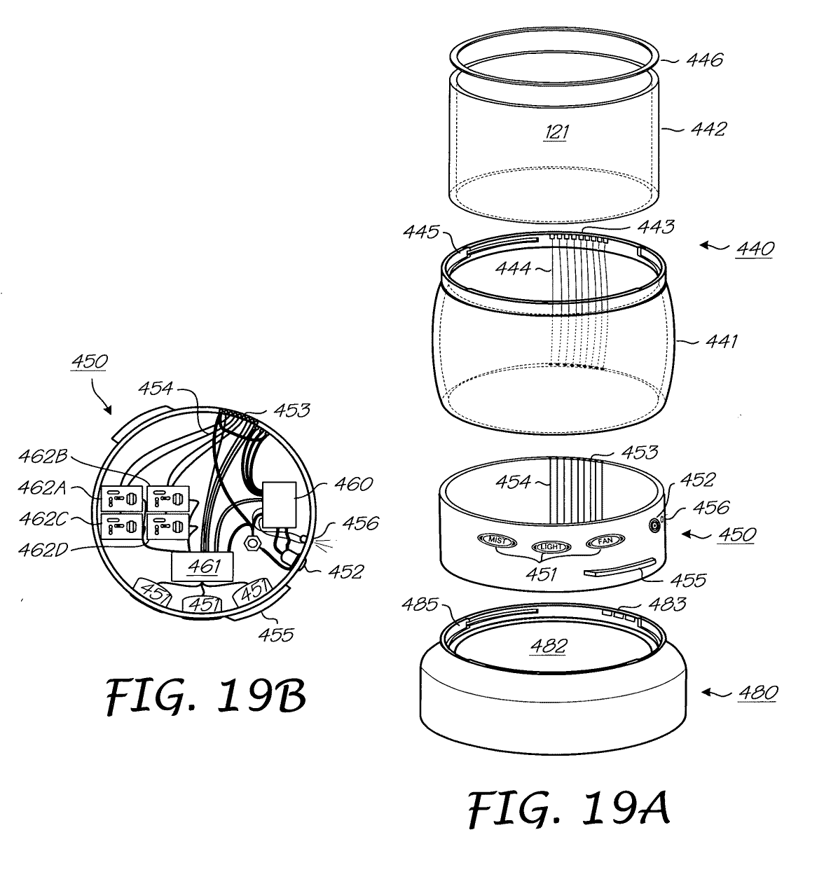

The operation of the nebulizer assembly will be better understood from a discussion of it components. FIG. 17 is an exploded diagram of repellent humidifier 400 that further illustrates a highly decomposed view of nebulizer assembly 410 in accordance with another exemplary embodiment of the present invention. To the left of the diagram is the mechanical-electrical cooperation between control assembly 450 and battery assembly 480 can be appreciated (a more decomposed view will be discussed below with regard to FIGS. 19A and 19B). Repellant 121 is present and sealed in the interior of tank assembly 440 from egressing nebulizer assembly 410 via tank seal 446. Exemplary nebulizer assembly 410 is formed from three structural components: upper surface 434 (with mounting surface for an optional fan), mounting housing 431 (with optional sockets for holding LED lamps and/or fan inlet (not shown) and transducer mounting surface 430. Transducer mounting surface 430 is secured within mounting housing 431 by some waterproof means (either glue, ultrasonic welds or fasteners with outer seal in order to allow the lower edge of mounting housing 431 to seal on seal 446 without allowing liquid repellant to escape onto the upper surface of transducer mounting surface 430. Upper surface 432 is coupled to mounting housing 431 using a twist-lock coupler (similar to the coupler between control assembly 450 and battery assembly 480 and between nebulizer assembly 410 and tank assembly 440) or removable fasteners, thereby enabling the operator access to the ultrasonic transducer(s) for maintenance.

In the present configuration, repellant 121 in tank assembly 440 is below the ultrasonic transducer(s), therefore the repellant is transmitted to the transducers for vaporization. Two primary methods exist: pumping (either using a mechanical pump or by pressurizing the repellant tank); or wicking using an absorbent wick. Pumps and pressuring devices are complicated, expensive, somewhat unreliable and drain the already limited power from the source. Wicks, on the other hand, are relatively uncomplicated, reliable and inexpensive. Wicking the repellant to the transducer requires only that the wick be exposed to the repellant, the greater the coverage the less capillary effect is necessary for transmission (although intermittent lapses will not affect the performance of the device if the wick is saturated), and the upper surface remain in contact with the surface of the transducer. In accordance with one exemplary embodiment of the present invention, rather that evaporating the repellant from a vibrating solid surface as discussed elsewhere above, here the repellant is drawn through tiny holes, slots, perforation and mesh in the vibrating surface of the transducer which, in turn, evaporates the repellant directly from the interior of the wick.

Before discussing exemplary repellant well and wick assembly 420, turn to FIGS. 18A, 18B, 18C and 18D for a brief discussion of exemplary ultrasonic transducer. In contrast with the transducer designs discussed above which evaporate liquids above the vibrating surface, ultrasonic transducer for wick-type humidifiers essentially evaporate the liquid in the upper portion of the absorbent wick. Hence, the vibrating surface of the transducer should be in contact with the wick, usually at the upper end surface, and should have a path for the vapor to escape. In accordance with various exemplary embodiments of the present invention, the vibrating surface of the ultrasonic transducer is permeable to vapors. FIGS. 18A and 18B (FIG. 18A depicting a top view and FIG. 18B depicting a side view) illustrate an ultrasonic transducer having a round vibrating surface, while FIGS. 18C and 18D (FIG. 18C depicting a top view and FIG. 18D depicting a side view) illustrate another ultrasonic transducer design having a linear-shaped round vibrating surface, however the external shape of the vibrating surface is not necessarily limiting to the presently described invention.

Turning to the exemplary embodiment of the transducer structure depicted in FIGS. 18A and 18B illustrate an ultrasonic transducer with a vibrating surface 415A juxtaposed to transducer (piezoelectric crystal) 414A with conductors leads 416A attached. Notice from the illustration that piezoelectric crystal 414A has an opening that exposes a permeable surface portion of vibrating surface 415A. Optimally, permeable vibrating surface portion 413A contacts an end of absorbent wick 421 and, therefore, for maximal efficiency the area of permeable vibrating surface portion 413A should be coextensive or slightly larger than the area of the end of absorbent wick 421. Wick 421 may be of virtually any length, longer lengths allow for a deeper repellant tank and more capacity, however the capillary effect becomes less efficient in delivering high amount of repellant to the transducer in excess of a foot. The permeable portion of the vibrating surface may be perforated, slotted, a mesh of small opening in vibrating surface 415A sufficiently large to allow vapor to traverse vibrating surface 415A, yet leaving enough surface material for efficient propagation of the oscillation energy. One optimal means for manufacturing the permeable portion into a vibrating surface is by selecting a perforation pattern over the portion of the vibrating surface where permeability is desired and laser etch the pattern through the vibrating surface. For optimal connectivity between vibrating surface 415A and transducer (piezoelectric crystal) 414A, the permeable portion should not extend beneath the area in contact with piezoelectric crystal 414A. In operation, this transducer design emits a medium velocity cone-shaped stream of repellant vapor in a direction generally opposite the absorbent wick. Additionally, while FIGS. 17, 18A and 18B generally suggest that vibrating surface 415A is oriented in a nearly horizontal plane, in practice each vibrating surface 415A on portable ultrasonic humidifier 400 may be oriented off horizontal in order to disperse the cone-shaped streams of repellant vapor away from each other and in a wide dispersion pattern about portable ultrasonic humidifier 400 (easily over forty-five degrees without suffering any operational inefficiency).

With regard to the exemplary embodiment of the transducer structure depicted in FIGS. 18C and 18D, the diagrams illustrate another ultrasonic transducer with vibrating surface 415B juxtaposed to transducer (piezoelectric crystal) 414B with conductors leads 416B attached. However, rather than the coextensive portions of piezoelectric crystal 414B and vibrating surface 415B having an open circular area, here the contact surface is closed with cantilever permeable vibrating surface portion 413B extending from the contact area in the cantilevered appendage. In this embodiment, optimally permeable vibrating surface portion 413B should contact only an end of absorbent wick 421 in order to transfer all of the oscillation energy to the repellant in the wick, but may be larger and non-coextensive with the wick end.

Returning now to FIG. 17, concentric transducer assembly 412 is secured into transducer well 419 on transducer mounting surface 430 by transducer assembly retainer 418 that mechanically couples to the seat and/or transducer surface, thereby securing concentric transducer assembly 412. Transducer seals 417 provide a fluid proof seal to prevent leakage of repellant onto the top surface of transducer mounting surface 430. Repellant well and wick assembly 420 (for brevity, herein after referred to as wick assembly 420) operates as a repellant well by using an absorbent wick to hold liquid repellent for the transducer. Wick assembly 420 mechanically couples to the under side of transducer well 419 using a pair of male support housing couplers 428 that cooperate with a female coupler on the transducer seat (not shown). FIG. 17 depicts portable ultrasonic humidifier 400 having four transducers and corresponding wick assemblies, however any number that will fit within the confines of the surface area are possible. With further regard to wick assembly 420, its purpose is to enable wick 421 to traverse the distance between concentric transducer assembly 412 and the repellant, preferable to the bottom of the repellant tank. Absorbent wick 421 pulls repellant from the repellant tank against gravity using the well-known capillary affect. Hence, absorbent wick 421 should be fabricated from a material having a relatively high longitudinal permeability to repellant and a somewhat lower lateral permeability to the repellant. Absorbent wick 421 may be fabricated from a variety of materials, typically nonorganic due to undesirable reaction between organic materials and the repellant, most common of which are oriented longitudinally in a loosely packed cylindrically shaped wick. Alternatively, the wick material may be a foam having similar flow properties. In any case, wick 421 should remain biased to permeable vibrating surface portion 413A of transducer assembly 412 by a few ounces per square inch of pressure. This is accomplished, in accordance with one exemplary embodiment of the present invention by using wick support housing 423 that is received into spring compression housing 426 for retaining a biasing member in a compressed state, such as exemplary wick support housing spring 425, essentially between support housing lock ring 424 on wick support housing 423 and the bottom surface of spring compression housing 426. The upper movement of wick support housing 423 within spring compression housing 426 is controlled by a pair of lock ring catches 427 that confine movement of support housing lock ring 424. As mentioned above, wick support housing spring 425 need only apply a few square ounces of pressure on wick 421 once installed on transducer mounting surface 430. Optionally, wick support housing 243 may be fitted with wick screen/filter 422 between wick support housing 423 and wick 421 to further filter contaminants from being absorbed into the wick.

Wick support housing 423 is retained in mounting housing 431, which optionally my include fixtures for receiving a plurality of LED bulb 438 (as a practical matter, LED bulbs may be electrically configured in banks of lights for efficiently distributing power from the battery). Upper surface 432 is received around transducer assembly retainers 418 at transducer openings 433. Optional fan 434 may be disposed on upper surface (fan mounting surface) 432 which redirects air from fan inlets 436 across adjustably rotatable louvers 435 for dispersing repellant vapor. Alternatively, the fan inlets may be disposed along mounting housing 431 allowing fan 434 to draw air from within mounting housing 431. In either case, the fan louver design enables a wider, more directed dispersion of repellant in a desired direction.

Power for optional fan 434 and optional lights 438, along with transducer signals are controlled within control assembly 450. The relationship between base/battery assembly 480, control assembly 450 and tank assembly 440 are graphically represented in FIGS. 19A and 19B in accordance with other exemplary embodiments of the present invention. Essentially, tank assembly 440 comprises repellant tank 442 surrounded and supported by outer housing 441. Outer housing 441 has three major functions: it provides structural support for repellant tank 442; a conduit for conductors 444 between control assembly 450 and transducer mounting surface 430; and female tank assembly coupler 445 for cooperating with male mounting housing coupler 437. Additionally, a plurality of electrical contacts 443 are provided, each of which corresponds to respective conductor 444 for electrically coupling tank assembly 440 with control assembly 450. Tank seal 446 prevents repellant from escaping tank 442. As a practical matter, outer housing 441 and the structure of control assembly 450 may be fabricated as a single unit, or as two pieces and joined or welded together. Surfaces that may contact the repellant should be highly reactive, thus some more economic plastics such as PVC and ABS may not be suitable. One exemplary material which is highly non-reactive to repellants is Viton, which is a registered trademark of and available from the DuPont E.I. DE Nemours & Company, Delaware, USA.

Control assembly 450 generally holds the electrical components securely in close proximity to battery assembly 480 with conductors 454 electrically coupled to tank assembly 440, via optional electrical contacts 443 for signals and operating power, and to electrical contacts 483 on battery 480 to the battery for receiving battery power and for charging the batteries. Essentially, exemplary control assembly 450 comprises a plurality of transducer driver circuits (depicted herein as 462A, 462B, 462C and 462D, which may also be disposed within mounting housing 431 and adjacent to the respective transducers), power controller/recharger 260 for receiving electrical power from any of adapters 492 via power receptacle 452, switches 451 for respectively controlling one of the ultrasonic transducers, optional fan and/or optional lights, and transducer/fan/light controller 461, electrically coupled to switches 451 and power controller/recharger 460 for transforming user inputs to switches 451 into operating signals for one or all of transducers 412, fan 434 and lights 438. Alternatively, transducer/fan/light controller 461 may be a more complex unit that utilizes power level information from power controller/recharger 460 and then efficiently meters electrical power to selected ultrasonic transducers and/or distributes power between multiple ultrasonic transducers and/or a fan and/or multiple banks of LED lights based on the power available to the device. In order to efficiently utilize electrical power and repellant, transducer/fan/light controller 461 may operate in several modes, a full power mode to distribute a maximum amount of repellant vapor and a reduced power or kick-down mode that deactivates one or more ultrasonic transducers after a predetermined time period. The kick-down operating mode not only saves electrical energy, but also reduces repellant usage to a maintenance level after the protected area has been effectively permeated by repellant. Additionally, because the presently described portable repellent humidifier may not utilize a repellant level detector, transducer/fan/light controller 461 may also include an internal timer for automatically deactivating the ultrasonic transducers after a predetermined time period to avoid transducer damage from running dry of repellant. Optimally, transducer/fan/light controller 461 will initiate an alert signal (either audible, visual or both) to the operator who then checks repellant level in repellant tank 442 and refills as necessary, and then restarts vaporization.

In accordance with still another exemplary embodiment, transducer/fan/light controller 461 may efficiently distribute power to the different electrical components based on the battery's charge. For example, at full battery charge or adapted to line power, transducer/fan/light controller 461 will activate all ultrasonic transducers, the highest fan speed and all banks of lights simultaneously. However, as the power available to portable repellent humidifier 400 decreases, transducer/fan/light controller 461 prioritizes power output. For instance, at 90% remaining power, all ultrasonic transducers will receive power, but only 50% of the power to the fan and lights is available (the highest fan speed and no lights, or all banks of lights and no fan, or half the light banks and half fan speed). At 80% available remaining power, all ultrasonic transducers will receive power, but only 25% of the power to the fan and lights is available (the medium fan speed and no lights, or one bank of lights and no fan). Additional fan and lighting capacity will be available if the user reduces the number of ultrasonic transducers activated. Ultimately, at low power LED light will be activated by transducer/fan/light controller 461. This power protocol is automatically instantiated. As less power is available from the battery, transducer/fan/light controller 461 automatically switches to lower power consumption states, i.e., beginning with lower fan power consumption, lower light power consumption and then on to lower transducer power consumption. Power status indicator light 456 emits a green indicator light above some threshold amount and red when the power available to transducer/fan/light controller 461 drops below the threshold level. Alternatively, transducer/fan/light controller 461, power controller/recharger 460 and/or battery assembly may be connected to an LED dot- or bar-type charge indicator and health gauge.

Operationally, portable repellent humidifier 400 should be uncomplicated. For instance, by depressing the MIST button once, transducer/fan/light controller 461 activates a single transducer, twice it activates two transducers, three depressions all of the transducers are activated, depending on the state of power availability from the battery. A subsequent depression of the MIST button will deactivate all of the transducers. Similarly, by depressing the FAN button once, transducer/fan/light controller 461 activates the lowest fan speed, sequential depressions activate the fan in higher speeds and finally deactivates the fan, as well as the LIGHT button, in which successive banks of LED bulbs are activated based on the number of successive depressions.

The presently described portable ultrasonic humidifier for repelling insect pests invention is different from that known in the prior art in its battery-powered operation. The present invention may be powered by a 110 or 220-volt line power sources or the internal battery. In the battery mode, the ultrasonic humidifier can be located in areas where line current is not available, such as patios, pavilions, pool areas, back yards, along fence lines, etc., in addition to other places where pests are attracted to people and pets with line power, such as restaurants, pavilions, common areas in condos and apartments entrance, and generally anywhere that pests come in contact with humans or animals. Since the product operates without the need of an external power source, it can be used in virtually any location where insects may be attracted. Furthermore, the battery may be replaced as needed, usually simultaneously with refilling the repellant tank, or instead may be charged conventionally using an onboard low voltage line charger or a solar panel. The portable ultrasonic humidifier trades off capacity and size for convenience, thus not fit for every application. For instance, applications needing more repellant capacity without space for accommodating a multitude of small portable humidifiers.

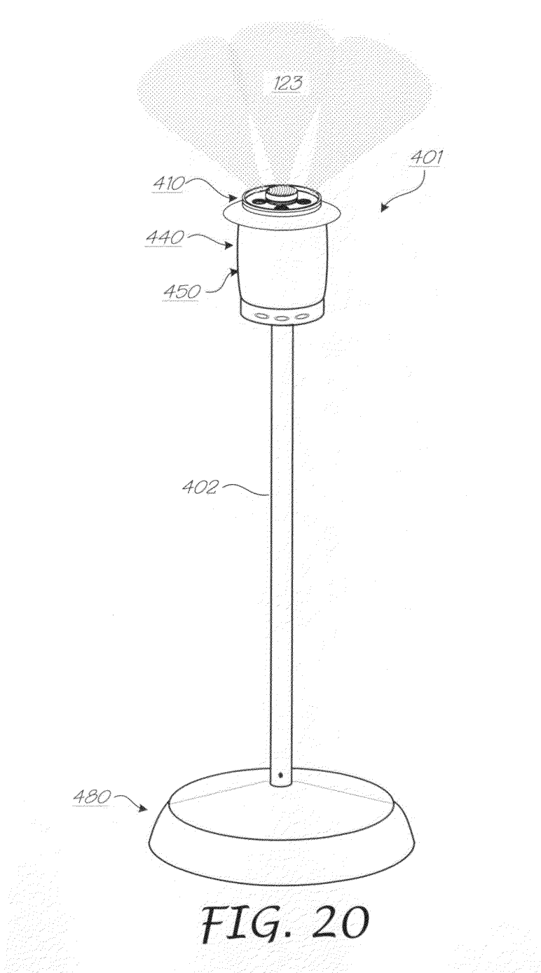

FIG. 20 depicts a portable patio repellent humidifier 401 in accordance with another exemplary embodiment of the present invention. Here, patio repellent humidifier 401 is similar to portable repellent humidifier 400 with the inclusion of extension 402 for elevating at least nebulizer assembly 410 above base assembly 480. It is often advantageous to elevate repellant vapor 123 for better and more homogeneous dispersion. Furthermore, because portable patio repellent humidifier 401 is floor mounted, it can achieve a scale of size. Additionally, in some facilities the amount of horizontal surfaces are limited, such as outdoor restaurants, patios, tailgating areas and pool areas. It is expected that most commercial establishments will have power outlets throughout and, therefore, base 480 may not contain a battery, but instead may connect to a power input cord.

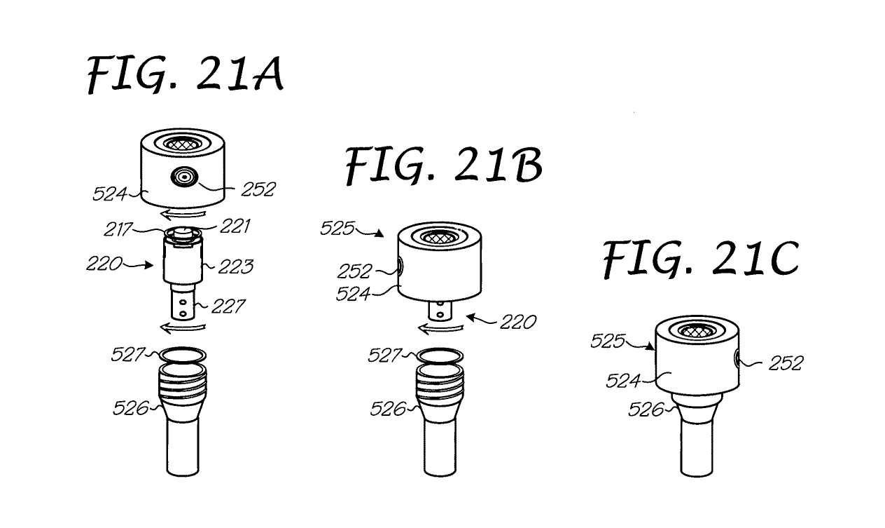

In accordance with still another exemplary embodiment of the present invention, wick-type transducer assemblies discussed above in FIG. 17 may be disposed remotely along low-pressure repellant tubes that, rather than for providing pressurized liquid repellant for misting, merely keep the absorbent wicks covered in repellant for vaporizing by the ultrasonic transducers. FIGS. 21A, 21B and 21C depict remotely positionable transducer assembly 525 that is adaptable to conventional threaded pipe sub 526, such as a hose nibble or the like, in accordance with an exemplary embodiment of the present invention. Remotely positionable transducer assembly 525 essentially comprises transducer assembly head 524 coupled to wick assembly 420. Here, wick assembly 420 may be identical to that described above with regard to FIG. 17, but includes seal 417 to prevent repellant from contacting the ultrasonic transducer assembly without traversing absorbent wick 421. This feature channels all of the repellant into the ultrasonic transducer through the wick, which effectively modulates the repellant flow and pressure, there by preventing liquid repellant from reaching the ultrasonic transducer directly. Here, remote transducer assembly head 524 not only contains the ultrasonic transducer, but also a transducer driver circuit. Electrical power for the transducer and driver circuit is received at power receptacle 452. The aim is to provide a repositionable transducer assembly that is adaptable to a standard pipe fitting, thereby enabling a large area to be protected by repellant. It is expected that a plurality of remotely positionable transducer assemblies 525 will be configured along a permanent distribution tubing.

The structure and operation of an exemplary embodiment of the present invention for use with remotely positionable transducer assemblies 525 will be appreciated through a discussion of the ultrasonic humidifier system for repelling insect pests illustrated in FIGS. 16A and 16B. Automated ultrasonic humidifier system 500 generally comprises two subcomponents, controller unit 550 and dispersing elements 520. Dispersing elements 520 includes risers and tubing 522 for routing the low pressure liquid repellant to a plurality of remotely positionable transducer assemblies 525 for dispensing repellant vapor 123, as generally discussed above. The location and orientation of tubing 522 and remotely positionable transducer assemblies 525 depends on the particular application, i.e., the location, availability of mounting surfaces for tubing 522, availability of electrical power, etc. As a practical matter, the positioning and quantity of remotely positionable transducer assemblies 525 should be based on the desired repellant pattern and coverage, and the amount of repellant flow that each transducer assembly head can disperse. As discussed elsewhere above, for flying pests, a fine vapor of repellant is far more effective in deterring insects than a mist and a vapor has the added advantage of having a relatively long fallout rate where the repellant vapors remain airborne.

With further regard to automated ultrasonic humidifier system 500 illustrated in FIGS. 16 A and 16B, controller unit 550 is far different from that known in the prior art for dispersing a repellant vapor, in that controller unit 550 is a self-contained reservoir system for automated vaporization of repellants at long distance from the repellant reservoir. Certain components require protection from the weather and/or should be secured from access by the general public. Thus, controller unit 550 includes a weatherproof enclosure of enclosure cabinet 552 and sealing door 554, which is pivotally attached to cabinet 552 by hinges 556. Cabinet 552 and door 554 may be any type of wall mounted storage cabinet and made of any high impact and generally non-reactive material such as PVC, or ABS plastics, fiberglass or acrylic, however if cabinet 552 and door 554 will be directly exposed to the repellant, Viton may be a better choice. Cabinet 552 may be fitted with a plurality of mounting holes 551 for securing the enclosure to a permanent structure by receiving mounting fasteners 553 and should have a volume sufficient to comfortably house a 2 or 2½ gallon container (however, any size removable container may be used that is suitable for holding repellants, or alternatively, the container can be integrated in the structure of cabinet 552), repellant tank 502, along with battery 538, low-pressure pump 534 and programmable controller 536. Additional space should be provided between low-pressure pump 534 and other heat sensitive components, as well as for performing routine maintenance such as interchanging and refilling repellant tank 502. Battery 538 may be any of a variety of DC batteries (such as a commonly available 12-volt, 18-volt, 24-volt, or other voltage that is compatible with the pump and remotely positionable transducer assemblies 525), but should be rechargeable. Also, because of the proximity to repellant vapors and sparkling at the pump motor brushes, a sealed dry cell type battery is preferable over a wet cell, although either type will suffice. Recharging unit 540 may also be provided for recharging battery 538, an external port for connecting an AC source should be provided for convenience, or alternatively, an external DC port may be provided for connecting an external recharging unit. The heart of controller unit 550 is programmable controller 536, which receives programming instructions from the operator on keypad 535 and, using onboard programming and logic, schedules vaporizations, monitors time and a variety of inputs from various sensors and, based on the information from the sensors and the vaporization schedule, initiates the ultrasonic transducer operating sequences. Programmable controller 536 may include a microprocessor, clock, controller interfaces and ROM and RAM type memories as necessary for storing, reading and writing program code, data and time/dates for executing the timing sequence and self-checks. Programmable controller 536 may instead be configured as a timer for setting a mist schedule, either manually or electronically. It is expected that if automated ultrasonic humidifier system 500 is installed at a commercial establishment, operating hours and peak patronage time periods will be known, or at least understood well enough to preprogram vaporization times and durations. Alternatively, in smaller commercial and non-commercial applications, ultrasonic humidifier system 500 may be activated manually, or via inferences from motion and/or IR sensors indicating that humans are present in the repellant coverage area.

A battery backup may be provided for programmable controller 536 for retaining programming instruction, timing and misting schedules and the like in case the primary battery 538 fails or is temporarily disconnected. Programming, maintenance and running modes may be selected using rotary switch 539 and the user inputs and other values monitored on display 537, which may be any type of single/multiline readout or display, such as LCD or LED.

Programmable controller 536 sends and receives signals from other onboard components using one or more data busses, usually secured to the backplane of cabinet 552, shown here as data bus 542 and reservoir bus 545. This bus configuration is merely exemplary and is used herein only to describe aspects of the present invention. Data bus 542 terminates at outer connector 543, which is used for electrically coupling programmable controller 536 to external sensors, switches and communication components. Data bus 542 also provides conductors for a switching current to pump control switch 532 for completing a conducting path to battery 538 that energizes pump 534 and draws repellant from repellant tank 502, via inlet tube 503. In accordance to one exemplary embodiment of the present invention, pump control switch 532 also energized transducer power bus 546, which in turn powers transducer power conductors 523 coupled between remotely positionable transducer assemblies 525 and energized transducer power bus 546, via external power conductor coupler 547. Pump control switch 532 is typically a relay or solid state device in which the high current path necessary for operating low pressure pump 534 is connected directly to the pump rather than through programmable controller 536.

Low pressure pump 534 should have a rating between 10.0 PSI and 20.0 PSI to assure that an adequate flowing pressure of between 1.0 PSI and 5.0 PSI can be maintained in remotely positionable transducer assemblies 525 during vaporization operations. The aim here is to provide a volume of repellant at each wick assembly 520, but without driving through the wick and directly into remote transducer assembly head 524 at a rate faster than can be vaporized by the ultrasonic transducers. As it is expected that the head height of remotely positionable transducer assemblies 525 above low pressure pump 534 will be between three and ten feet, low pressure pump 534 should deliver between 5.3 PSI and 9.3 PSI in order to achieve a flowing pressure of between 1.0 PSI and 5.0 PSI, assuming the density of the repellant approximates that of fresh water and no pressure loss in tubing 522. Typically, a rating of 10.0 PSI will suffice for a site having five of fewer transducer assembly heads. However, the pressure requirement for larger systems increases with the number of transducer assembly heads employed and the distance to the pump (resulting from pressure losses in the tubing). For example, a pump rating of 16.0 PSI may be needed for supporting misting in up to 20 transducer assembly heads while a pump rating of 25.0 PSI or greater may be necessary for supporting misting in 40-50 transducer assembly heads.

Here it should be mentioned that the selection of the wick material is of some consequence as to the overall performance of any of the above-described embodiments. While water-type wick humidifiers have achieved widespread acceptance, the use of wicks with repellant is far less satisfactory than for water. Initially, even when used with water, the efficient of a wick delivery system decreases markedly over time. To that end, most humidifier manufacturers provide one of more replacement wicks with a unit. Furthermore, conventional water humidifiers typically use the wick as a medium for creating an evaporative surface. To that end, floor model humidifiers almost exclusively use large surface area filter/wicks, some of which surround the fan in a cylindrical shaped configuration that offers an extremely large volume of wick material. In so doing, water may traverse the wick over a variety of paths and may create new, more easily traversed pathways as old channels become impassable. Hence, the selection of a large wick enables the material to absorb clogs without degrading the overall performance of the humidifier. Moreover, typical humidifier wicks become soiled not from the water being transported, but from contaminates in the air that passes across the wick/filter. This type of evaporation is more passive than using an ultrasonic transducer and its efficiency is directly related to the relative humidity of the ambient air. The present described wick humidifiers utilize a wick as a pseudo repellant well, for transporting repellant to the transducer.

The problems associated with wicks are exacerbated for vaporizing fluids such as repellants with different hydraulic properties than water and that are comprised of complex organic chemistries that behave differently from water in a capillary environment. Testing has reveled that certain repellants and certain wick products behave far differently from water in a capillary of a wick. It has been discovered that repellants substantially shorten the useful life of most porous materials used in wicks, such as expanded paper. Moreover, test results have largely been inconsistent. During testing, in certain cases wick performance would not always decrease in a predictable fashion, sometimes large decreases in performance were detected over relatively short operating intervals, followed by a relative recovery in efficiency. Repeatability of results ahs also been suspect as the performance of certain wick materials would tend to fall off in one run, but not in others. Furthermore, and perhaps more importantly, predicting the performance of a certain wick material is difficult because predicted drops is performance are not always constant, steady and stable, but are often inconsistent. A humidifier running at a reduced performance efficiency will sometimes regain lost efficiency. It is speculated that the interaction of the repellant and the wick material is not constant and/or the repellant itself may act as both as condensate on the material, thereby clogging fluid paths and under certain conditions, a repellant solvent that emulsifies solidified repellant thereby creating new repellant paths for the repellant to be drawn to the ultrasonic transducer. As a result, it is expected that wicks used in the presently described invention should be replaced regularly.

The present invention does more than merely dispense repellants on a predetermined schedule, but intelligently vaporizes a protected area based on several dynamic variables. These include: the state and operational status of automated ultrasonic humidifier system 500; the presence or absence of humans in the protected area; and weather conditions. These will be discussed below, however certain sensing devices may be incorporated, either internally or externally for sensing information used by programmable controller 536 in deciding whether or not to activate remotely positionable transducer assemblies 525 above low pressure pump 534 at a predetermined time. For example, weather sensor 574 senses the current weather condition and passes that information on to programmable controller 536. It is important to activate the humidifier only when pests are active and when the vaporization will be effective against the pests. Therefore, weather conditions that do not favor pest activity should be recognized to avoid wasting the repellant product. One metric of pest activity is light, for instance certain species of mosquitoes, such as the Aedes mosquitoes attack only during daylight hours, not at night and are far less active during overcast and foggy days. Therefore, if pests to be controlled in the protected area can be identified as being predominantly active in the day light, or conversely at night, a light sensor would provide information to programmable controller 536 that would preclude vaporizing during periods when pests are not active. The presence of a light sensor may also save repellant, for instance, if the vaporization schedule is incorrectly programmed, the days are extremely overcast, or dusk arrives early after the summer solstice that has not been reconciled in the schedule, light sensing can be used to extend or truncate the scheduled vaporization period as desired by overriding the schedule. A second metric is wind speed. Clearly, vaporization operations will be less effective in higher wind speeds, or gusts, above a predetermined threshold amount, for example a threshold of approximately 8 mph with a reset speed of approximately 3 mph (similarly, many pests are far less active in windy conditions). Upon receiving information that the wind speed is above the threshold, programmable controller 536 disables the vaporization operation until wind conditions are more favorable. Programmable controller 536 may either cancel any vaporization that is scheduled during a period where wind speed exceeds the wind threshold, or may instead delay the vaporization for a predetermined time period until the wind speed drops below the threshold. Additionally, vaporization operations will be ineffective during precipitation events, therefore a third metric is rain detection. Here again, if weather sensor 574 passes information to programmable controller 536 that rain is falling, the controller cancels vaporization. Another metric that is indicative of pest activity is the temperature. Many insects are more active at certain temperatures and inactive outside that temperature span. Thus, vaporization is ineffective. For example, many types of pests are inactive in temperatures below 55° F. (12.8° C.), and therefore, if weather sensor 574 passes information to programmable controller 536 indicating the outside temperature is not within the tolerance of the adult population, misting operations should be suspended during those periods. Another metric under investigation is barometric pressure. It has been established that certain insects can sense change in barometric pressure that may indicate the onset of severe weather. Some species of pests become extremely active at the onset of a drop in barometric pressure in foraging. If those periods of activity can be predicted by programmable controller 536, the vaporization schedule can be dynamically adjusted to repel pests during periods of heightened activity brought about by a perceived change in the weather. Thus, weather sensor 574 passes barometric pressure information to programmable controller 536, which compares the information to pressures that are known to result in increased activity of pests. If all other conditions are favorable, e.g., light, wind, rain, system status, etc, programmable controller 536 may trigger an immediate vaporization sequence.

Returning to enclosure 552, other conductors may be provided for signaling the position of door switch 548 to programmable controller 536 and for connection 565 for coupling to external control panel 560 located on the outer side of enclosure door 554. External control panel 560 provides a means for monitoring the status of programmable controller 536, as well as an interface for communicating certain user commands to programmable controller 536. For instance, visible on external control panel 560 are status indicator lights 564 representing the state of programmable controller 536, for instance status indicator lights “ON,” “LOW FLUID,” “FAULT,” and “OFF.” Using these indicator lights, anyone can quickly assess the health and status of the controller without any training whatsoever. As depicted in the figure, the ON indicator light is burning indicating that rotary switch 539 is in the RUN position, the system is active and functioning normally. If, however, either the FAULT or LOW FLUID indicator light is glowing, a service person should be contacted to ascertain the source of the fault or to refill repellant tank 502. The FAULT indicator light is activated any time that programmable controller 536 senses an internal error, such as low voltage condition, an empty repellant reservoir, memory glitch or loss, etc. If the OFF indicator light is glowing, the system has been shut down by the operator using rotary switch 539 and the system is in an inactive operational state.

External control panel 560 also provides an external switching mechanism for someone in the vicinity of the protected area to manually initiate vaporization without opening door 554, i.e., by depressing VAPOR button 566, or to terminate an ongoing vaporization cycle, by depressing OFF button 562. Another convenience feature of the present invention that will be discussed in greater detail is audible and visual alarms that alert to vaporization. Because repellant vapor 123 is virtually invisible, the operator may not appreciate when or for how long automated ultrasonic humidifier system 500 is active. Thus, unit 550 may be fitted with optional vaporization light 576 and/or optional audible alarm 578 to alert the operator that the vaporization is ongoing or pending. Optional vaporization light 576 may be any color of visible light that can be seen over the protected area, yet will not so bright as to detract from ambience of the scene. Optional, audible alert 578 should be loud but not ear splitting loud, and preferably accelerate the cadence pitch or cycle temporarily corresponding to the approach of the vaporization cycle. Typically, a single short tone followed by another alert tone after some predetermined time interval. For example, one minute prior to the vaporization, warning light 576 will flash and optional audible alert 578 will sound. As the vaporization time gets closer, the audible alarm will sound again, perhaps at an increased level, as may the intensity of warning light 576. The alerts will continue, albeit at lower, less distractive levels, until the vaporization ceases. In this way, someone working proximate to automated ultrasonic humidifier system 500 will have more than sufficient time to depress OFF button 566 to stop vaporization, even before the cycle initiates.

Additionally, programmable controller 536 may be coupled to a wireless receiver (not shown) for receiving instructions from a remote wireless transceiver. Typically, the transceiver is maintained in a secure location, such as inside the premises, but available to the employee for activating and deactivating a vaporization sequence. The transceiver will receive operational state information from automated ultrasonic humidifier system 500 which is displayed on the transceiver. Obviously, the same principle can be employed using VAPOR button 562 and OFF button 566.

Depending on the coverage area, repellant tank 502 contains a sufficient amount of repellant mixture to enable automated vaporization for between one and four days between service calls. The exact number of vaporization cycles supported by the amount of repellant in repellant tank 502 will vary depending on vaporization times, durations entered by the operator at programmable controller 536 and the size of repellant tank 502. The vaporization schedule (time and duration) is dependent on two variables: pest activity and human presence. If either is negligible, a vaporization cycle may be skipped. For example, Aedes mosquitoes and certain types of no see urns, midgies, sand flies, punkies and biting flies are usually more active in daylight hours, however humans may not be present in the protected until afternoon. Thus, if those types pests are primarily responsible for discomfort, vaporization sequences should be limited to afternoon hours when humans (or pets and livestock to be protected) are present and not night or mornings. The first step in scheduling vaporization sequences is always to investigate the site by inspecting the area and assessing the habits of the target pest and proximity to humans. Obviously, some amount of training may be necessary to more accurately assess the pests' habits from a single site inspection. Optimally, a 2½ gallon repellant tank is designed to humidify repellant for in excess of sixteen hours (this assumes that five or fewer transducer assembly heads are used). This will ensure that the system will not run out of product for at least a day. This fits into the daily pest control routine of most commercial establishments. Given the parameters mentioned above, the operator can program vaporization schedules for any combination of vaporization times, for instance continuously throughout the vaporization cycle, two minutes activated and then one or two minutes off, etc. Systems with more than eight transducer assembly heads should have an exterior reservoir to avoid having to fill the system too often. The more transducer assembly heads used on the system, the more product will be dispensed. Typically, there are some constraints on programming the mist schedule at programmable controller 536, for instance, vaporization times are limited to 16 discreet times a day with a maximum mist duration of two hours for each sequence. This is a function of the hardware timer or software application loaded on programmable controller 536 and may be altered. However, some constraints should be established to prevent over-misting an area.

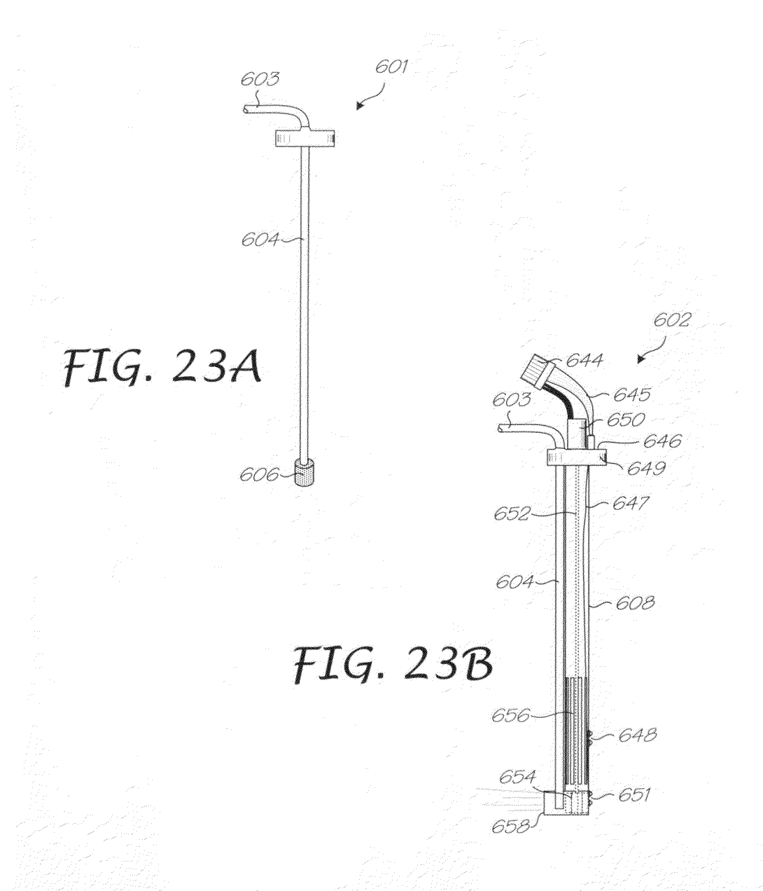

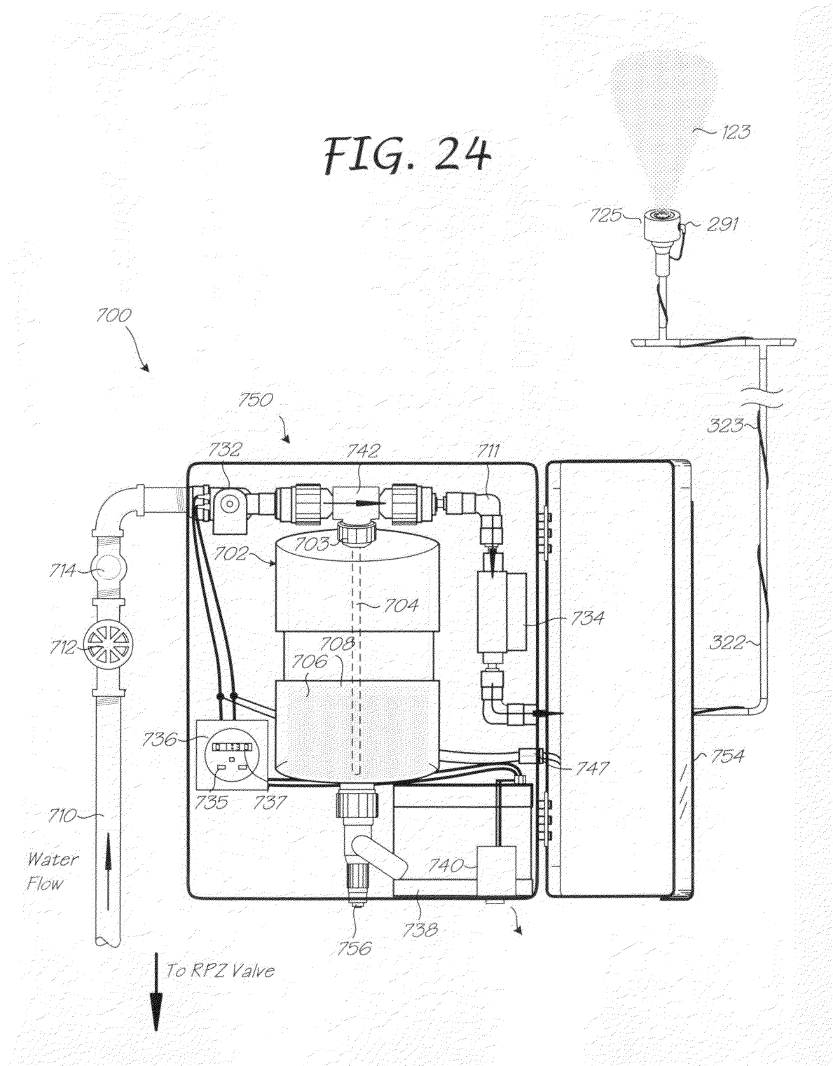

In accordance with one exemplary embodiment of the present invention, repellant is drawn from repellant tank 602 through suction tube 604 and ported through cap 646. FIG. 23A illustrates a suction assembly in accordance with one exemplary embodiment of the present invention while FIG. 23B illustrates an agitator suction assembly in accordance with one exemplary embodiment of the present invention. In either case, a filter is installed either on suction tube 604 shown as submersible filter 606 or on inlet tube 603 depicted as external filter 606. The filter prevents congealed repellant and other foreign matter from clogging transducer assemblies 525 or damaging pump 534. However, because repellant tank 502 contains a pre-mixed dilution of repellant and water, some settling may occur between vaporizations. Therefore, and in accordance with one exemplary embodiment of the present invention, repellant tank 502 may be fitted with an agitator for stirring the repellant mixture prior to each misting (see FIGS. 23A and 23B). The agitator will include agitator motor 650, shaft 652 and agitator impeller 654 disposed within repellant tank 502 near the bottom. Agitator impeller 654 may be an exposed “pinwheel” type, or may be contained in agitator housing 608 with agitator intake slots 656 for receiving fluid and agitator outlet 658 for exhausting the fluid at some velocity for mixing. Agitator motor 650 receives power and/or run signals from programmable controller 536 over bus 545 (645 on FIG. 23B), and may be easily uncoupled for refilling repellant tank 502 using connection 544 (644 on FIG. 23B). Threaded ring 549 (649 on FIG. 23B) is also provided on cap 646 for tightening cap 646 to the spout of repellant tank 502 while enabling the operator to open repellant tank 502 without twisting the wires in reservoir bus 545.

In accordance with one exemplary embodiment of the present invention, a fluid sensor may be disposed along either suction tube 604, agitator housing 608, or on some other structure within the volume of repellant tank 502. As depicted, two sets of sensors may be employed. Low fluid sensors 648 are positioned at the low fluid level of repellant tank 502 and when uncovered by the repellant, indicate to programmable controller 536 that the repellant level should be checked and refilled. Upon sensing a low fluid condition, programmable controller 536 will activate the “LOW FLUID” external indicator light 564. Empty sensors 651 are positioned at the empty fluid level of the reservoir and when uncovered, empty sensors 651 indicate to programmable controller 536 that the fluid is empty. Upon sensing an empty fluid condition, programmable controller 536 will immediately suspend misting operations and activate the “FAULT” external indicator light 564.

In accordance with another exemplary embodiment of the present invention, greater capacity may be achieved by using concentrated repellant in a repellant tank and by mixing the concentrate with water from pressurized water source with an injector that is connected to the dispersion elements. FIG. 24 is a diagram depicting an automated self-contained reservoir system for automated vaporization of repellant, for efficient control of pests in accordance with an exemplary embodiment of the present invention. Here, controller unit 750 generally comprises weatherproof enclosure 752 and sealing door 754 for holding internal repellant tank 702, injector 742, pressure regulator valve 734, solenoid valve 732, battery 738, and programmable controller 736.

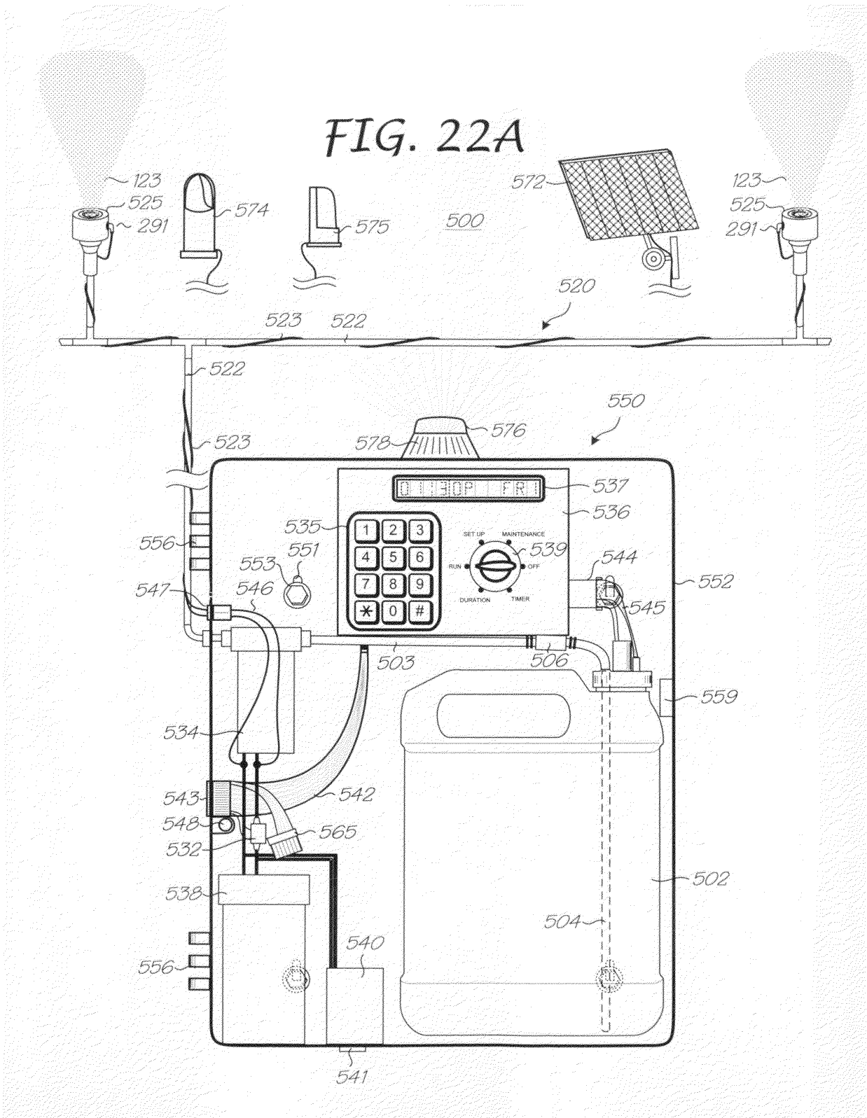

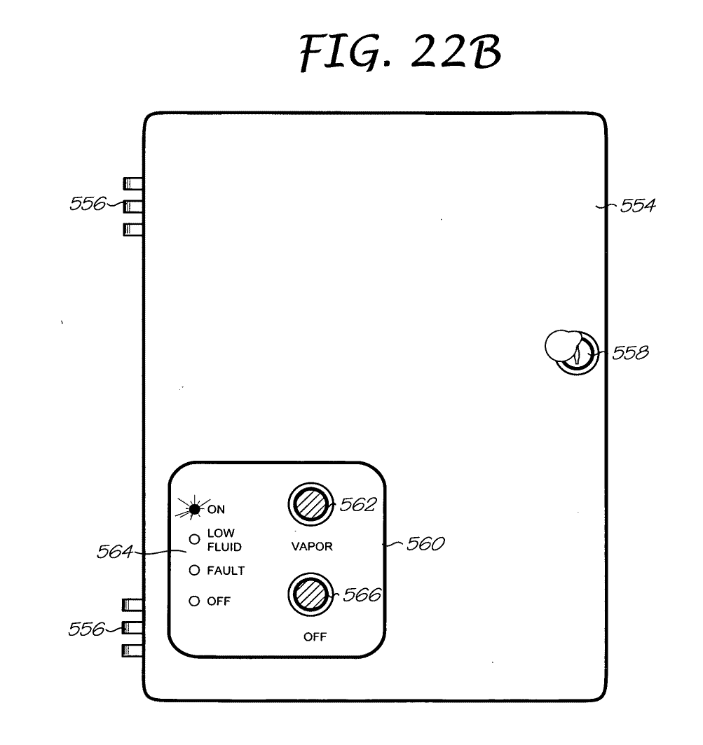

Here, the low pressure pump may be substituted with pressure regulator valve 734 that reduces the line water pressure from between 30.0 PSI and 60.0 PSI, to a rating between 10.0 PSI and 20.0 PSI described above with regard to low pressure pump in FIG. 22A. As also mentioned above, a lower pressure rating of 10.0 PSI will suffice for a site having five of fewer ultrasonic transducers.

Pressure regulator valve 734 is connected between the low pressure side of solenoid valve 732 and the dispersing elements, e.g., tubing 722 and nozzles 725. Solenoid valve 732 may be any type of electrically operable valve or regulating device that can reliably regulate the flow of water from injector 742, such as a ball, gate or diaphragm valve which operates by means of a solenoid, actuator, motor or other electro-mechanical device. Optimally, solenoid valve 732 should not react with the repellant in tank 702 or the minerals in the water from source 710.

A pressurized water source 710 provides fresh water to controller unit 750 through safety valve 712 and check valve 714 (typically a reduced pressure zone (RPZ) valve is also installed further upstream which provides additional protection from potential contamination). The tubing to the back side of solenoid valve 732 is at the pressure of the water supply 710. Pressurized water floods the cavity of injector 742 and any air-filled voids in repellant tank 702 (with the repellant) and into the normally closed solenoid valve 732 tubing between injector 742 upon being activated. An equilibrium state is achieved in which repellant tank 702 and injector 742 are flooded. In the equilibrium state, the fluid is motionless. Rather than containing a diluted repellant mixture, as used in Automated Ultrasonic Humidifier System 300 discussed above, repellant tank 702 holds concentrated repellant. Typically, the concentrated repellant held within repellant tank 702 is either more or less dense than water, causing the concentrated repellant and water to separate into distinct strata when in the equilibrium state. If the concentrated repellant is denser than water, the concentrated repellant will migrate to the bottom portion of repellant tank 702, below repellant stratum level 706 (above which is stratum 708 comprised of a relatively thin stratum of diluted repellant). Therefore, the opening of suction tube 704 should be located within the repellant stratum. If the concentrated repellant is more dense than water, the opening of suction tube 704 should be positioned proximate to the bottom of the reservoir (as depicted in the figure), alternatively, if the concentrated repellant is less dense than water, the opening of the suction tube should be positioned near the top of repellant tank 702. In cases where the concentrated repellant is less dense than water, it is sometimes desirable to route suction tube 704 to the bottom and then back to the top portion of the reservoir rather than merely truncating the suction tube near the top of the reservoir. Additionally, and as will be discussed below, because the repellant that is drawn out of the reservoir is replaced by water from the injector, it is also preferable to provide a replenishment tube to the bottom of the reservoir which allows the more dense replacement water to fill from the bottom, thereby minimizing unwanted mixing with the concentrated repellant.

Optimally, programmable controller 736 receives electrical power from AC power port that is ported directly to an AC line power source, and on to battery 738. A battery backup may also be included in case battery 738 fails. Programmable controller 736 includes, or is coupled to a switching mechanism (internal or external to controller 736). The switch (not shown) is a relay or solid state device in which the high operating current for operating pressure regulator valve 734, is regulated. Solenoid valve 732 is also connected to the switch (and/or controller 736) and connected parallel in with pressure regulator valve 734. Battery 738 may be any of a variety of DC batteries, as discussed elsewhere above, in any commonly available voltage that is compatible with the electrical components, preferably a sealed dry cell type battery. Vaporization schedules are programmed into programmable controller 736 using buttons 735 and the times and other information may be verified using display 737.

Although not specifically depicted in the figure, system 700 may be configured with any or all of the external components as discussed above with respect to FIGS. 22A and 22B, including, for example, weather and motion sensors and a solar cell for recharging battery 738. Onboard recharging/rectifying unit 740 is provided and optimally includes an external AC power port 741, an AC source, or, alternatively, a DC port may be provided for connecting an external recharging unit.

Programmable controller 736 monitors time and other parameters for determining optimal conditions for misting. Once programmable controller 736 decides conditions favor for vaporization, programmable controller 736 simultaneously directs power to both solenoid valve 732 and pressure regulator valve 734 (for example, via a control signal to the switching mechanism). Normally-closed solenoid valve 732 becomes energized, causing the valve to open, and the pressurized water and repellant flows into pressure regulator valve 734 (optimally pressure regulator valve 734 is a passive valve, but alternatively may operate electrically). Pressure regulator valve 734 receives water from water supply 710 and across injector 742. Injector 742 is a venturi-like device that mixes repellant concentrate with fresh water from pipe 710. As water flows across injector 742, a low pressure is created that draws concentrated repellant from internal repellant tank 702 (by suction tube 704) and through a calibrated metering orifice of the injector and into the water in the body of the injector, but at a rate determined by the size of the metering orifice. The concentrated repellant and water mix in the body of injector 742 are drawn to pressure regulator valve 734. Once in pressure regulator valve 734, the pressure of the mixture is increased from a pressure approximately equivalent to that of the municipal water (65.0 PSI or less), to over 100.0 PSI which is optimal for transporting repellant mixture to the transducers, and exhausts the mixture through outlet tube/riser 722 to the dispersing elements.

As should be appreciated, the present invention has all of the advantages of the control unit discussed above with respect to FIGS. 22A and 22B, but with drastically increased capacity. However, servicing control unit 750 may require a technician to refill repellant tank 702 with concentrated repellant. Recall that as the concentrated repellant is drawn out of repellant tank 702 it is replaced by water. Thus, repellant tank 702 is never empty, but full of water that must be replaced by concentrated repellant. This is accomplished by switching controller 736 to OFF or MAINTENANCE and then closing valve 712. With a recovery container attached to drain valve 756, the valve is opened slowly, allowing the pressurized water to drain into the recovery container. After the pressure is released, refill cap 703 is loosened and the remaining fluid will pour into the recovery container and drain valve 756 closed. The recovery container is uncoupled from drain valve 756, sealed and disposed of properly. With repellant tank 702 empty, repellant can be refilled in repellant tank 702 through the opening beneath cap 703. Care should be taken to avoid overfilling. Once complete, cap 703 is replaced tightly, and valve 712 is opened slowly to allow the internal pressure to reach equilibrium. Finally, controller 736 is switched back to RUN and cabinet door 754 closed and locked.

The exemplary embodiments described below were selected and described in order to best explain the principles of the invention and the practical application, and to enable others of ordinary skill in the art to understand the invention for various embodiments with various modifications as are suited to the particular use contemplated. The particular embodiments described below are in no way intended to limit the scope of the present invention as it may be practiced in a variety of variations and environments without departing from the scope and intent of the invention. Thus, the present invention is not intended to be limited to the embodiment shown, but is to be accorded the widest scope consistent with the principles and features described herein. Additionally, since the embodiments were elected to best explain the principles of the invention and the practical application of the invention and features of the inventions, one of ordinarily skill in the art will readily understand that features described with respect to one embodiment may be combined and practiced with other embodiments without regard or limitation from embodiment description.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. An ultrasonic repellent humidifier for dispersing insect repellant into the air as a micro fine repellent vapor, comprising:
a liquid repellant;
a repellent tank section, comprising:
a lower surface;
a repellent tank, said repellant tank having an interior tank volume for holding the liquid repellent and a tank opening; and
a tank valve coupled to the tank opening;
a repellent well having an outer well surface and an interior well volume for holding the liquid repellent;
a humidifier chamber having an interior chamber volume wherein the interior chamber volume comprises the interior well volume and is partially defined by the outer well surface of the repellant well;
a well level sensor assembly for sensing a level of the liquid repellent in the interior well volume of the repellent well and for sending a signal based on the level of the liquid repellent in the interior well volume of the repellent well, said well level sensor assembly comprising:
a hollow pedestal being vertically aligned and disposed at least partially within the interior well volume of the repellent well, said hollow pedestal having an exterior surface and a hollow interior and having a sealed upper end for isolating the hollow interior from the interior chamber volume;
a float slidably coupled to the exterior surface of the hollow pedestal, wherein said float slides vertically along the exterior surface of the hollow pedestal with the level of the liquid repellent in the interior well volume of the repellent well; and
an electrical sensor disposed within the hollow interior of the hollow pedestal for sensing a vertical position of the float;
an ultrasonic transducer for pulverizing the liquid repellent in the repellant well into a micro fine repellent vapor;
a blower for generating an air stream, said blower comprising;
an air exhaust coupled to interior chamber volume; and
an air inlet; and
blower motor;
an impeller mechanically coupled to the blower motor for driving air from the air inlet to the air exhaust;
a vent;
a vapor duct coupled between the interior chamber volume and the vent; and
an electronic controller for controlling the ultrasonic transducer and the blower.

2. The ultrasonic repellent humidifier recited in claim 1, wherein the well level sensor assembly further comprises:
a magnet mechanically coupled to the float for producing a magnetic field, wherein the electrical sensor senses the vertical position of the float by sensing an intensity of the magnetic field.

3. The ultrasonic repellent humidifier recited in claim 1, wherein the interior chamber volume of the humidifier chamber is partially defined by the lower surface of the repellent tank section.

4. The ultrasonic repellent humidifier recited in claim 3, further comprising:
an elevated snorkel air vent having a hollow snorkel body vertically aligned and coupled between the air exhaust of the blower and the interior chamber volume, said hollow snorkel body having an upper vent opening to the interior chamber volume and a lower opening.

5. The ultrasonic repellent humidifier recited in claim 4, wherein the elevated snorkel air vent further comprising:
an upper end cap, wherein the upper vent opening is disposed along a vertical side of the hollow snorkel body.

6. The ultrasonic repellent humidifier recited in claim 5, wherein the upper vent is disposed along a vertical side of the hollow snorkel body opposite the ultrasonic transducer.

7. The ultrasonic repellent humidifier recited in claim 6, wherein the repellent tank section further comprises a snorkel recess disposed within the lower surface of the repellent tank section with a recess opening and a volume for receiving at least a portion of the hollow snorkel body and the upper vent.

8. The ultrasonic repellent humidifier recited in claim 1, wherein the tank valve further comprising:
a seal;
a valve shaft coupled to the seal;
a valve body slidibly coupled to the valve shaft with a seat for cooperating with said seal; and
a spring for coupled between said shaft and said valve body for biasing said seal against said seat.

9. The ultrasonic repellent humidifier recited in claim 8, further comprising:
a valve contact assembly comprising a valve actuator contact for actuating the valve shaft and separating said seal from said seat.

10. The ultrasonic repellent humidifier recited in claim 9, valve contact assembly further comprising:
a float coupled to the valve actuator contact for articulating the valve actuator contact and actuating the valve shaft and separating said seal from said seat based on the level of the liquid repellent in the interior well volume of the repellent well.

11. The ultrasonic repellent humidifier recited in claim 9, wherein the repellent tank is removable from the repellent tank assembly and said valve actuator contact is static, whereby said valve actuator contact articulates the valve shaft and separates said seal from said seat present in the repellent tank assembly.

12. The ultrasonic repellent humidifier recited in claim 1, further comprises:
a splash hood having a hollow body vertically aligned substantially over the ultrasonic transducer and coupled between the interior chamber volume and the vapor duct, said splash hood having a lower opening within the repellant well.
wherein the repellent tank is removable from the repellent tank assembly and said valve actuator contact is static, whereby said valve actuator contact articulates the valve shaft and separates said seal from said seat present in the repellent tank assembly.

13. The ultrasonic repellent humidifier recited in claim 1, wherein the liquid repellent comprises one of geraniol, cedarwood oil, (cymbopogon winterianus), lemongrass oil (cymbopogon citratus), rosemary oil (rosemarinus officinalis), wintergreen oil (gaultheria procumbens), thyme oil (thymus vulgaris), cedarwood oil alcohols, cedarwood oil terpenes and sodium lauryl sulfate.

14. The ultrasonic repellent humidifier recited in claim 1, wherein the liquid repellent comprises geraniol.

15. The ultrasonic repellent humidifier recited in claim 1, wherein the liquid repellent comprises geraniol and sodium lauryl sulfate.

16. The ultrasonic repellent humidifier recited in claim 1, wherein the liquid repellent comprises less than five percent of geraniol.
